(19) United States
(12) Patent Application Publication
(10) Pub. No.: US 2007/0042152 A1
(43) Pub. Date: Feb. 22, 2007

(54) High-capacity optical storage media

(76) Inventors: Jean-Marie Adam, Rosenau (FR); Peter Aeschlimann, Allschwil (CH); Jean-Pierre Bacher, Buschwiller (FR); Jean-Luc Budry, Rossemaison (CH); Urs Lehmann, Basel (CH); Colin Morton, Basel (CH); Beat Schmidhalter, Bubendorf (DE); Heinz Spahni, Frenkendorf (DE)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/551,318

(22) PCT Filed: Feb. 25, 2004
(86) PCT No.: PCT/EP04/50206

§ 371 Date: May 16, 2006

(30) Foreign Application Priority Data
Apr. 4, 2003 (EP) 03100908.7
Sep. 2, 2003 (EP) 03102687.5

(51) Int. Cl. B32B 3/02

(52) U.S. Cl. 428/64.1

(57) ABSTRACT

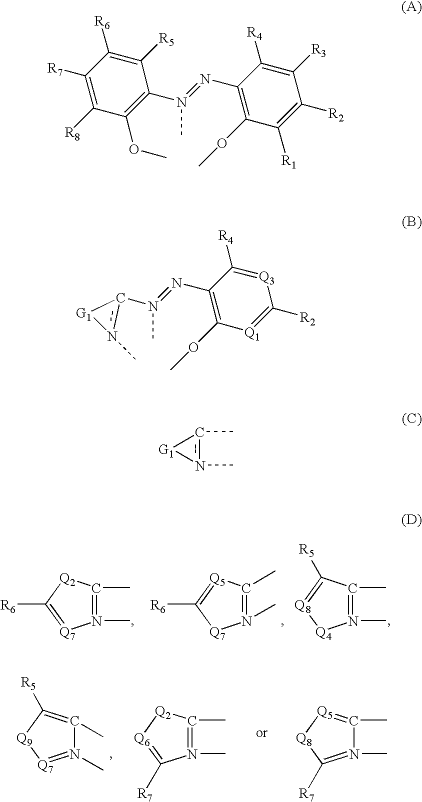

The invention relates to an optical recording medium comprising a substrate, a reflecting layer and a recording layer, wherein the recording layer comprises a compound of formula [L1Mr-4L-2]ₒ [A^{m}]ₚ [Zⁿ⁺_{q}(I), [L₁Mᵣ₋₃L−₃]₀ [Aₘ]^{P}[Zⁿ⁺]_{q}(II) or [L₃M^{r-2}L₄]₀ [A^{m}]ₚ[Zⁿ⁺]_{q} (III), or where applicable a mesomeric or tautomeric form thereof, wherein L₁ and L₂ are each independently of the other and L₃ and L₄ are each independently of the other wherein Q₁ is CR₁ or N, Q₂ is O, S, NR₁₀ or Q₅═Q₈, Q₃ is CR₃ or N, Q₄ is O, S, NR₁₀ or Q₇═Q₈, Q₅ is CR₅ or N, Q₆ is CR₆ or N, Q₇ is CR₇ or N, Q₈ is CR₈ or N, and Q₉ is 0, S, NR₁₀ or Q₆═Q₈; M^{r}, A^{m-}, Zⁿ⁺, R₂, R₉ are as defined in the claims.

The field of the invention is the optical storage of information on write-once storage media, the information pits being differentiated by the different optical properties of a colorant at written and unwritten sites. This technology is usually termed “WORM” (for example “CD-R”/“DVD-R”); those terms have been retained herein.

By the use of compact high-performance diode lasers that emit in the range of from 630 to 690 nm, it is possible in principle to achieve a 4- to 5-fold improvement in data packing density and a 6- to 8-fold increase in storage capacity in comparison with media having a blue or green layer, in that the track pitch (distance between two turns of the information track) and the size of the pits can be reduced, for example, to approximately half the value in comparison with conventional CDs.

This imposes extraordinarily high demands on the recording layer to be used, however, such as high refractive index, uniformity of script width at different length pulse durations and also high light stability in daylight with, at the same time, high sensitivity to high-energy laser radiation. The known recording layers possess those properties only to an unsatisfactory extent.

JP-A-02/55189 and JP-A-03/51182 disclose optical storage media in which the recording layer consists substantially of a cyanine dye and an azo metal complex, including, by way of example, an azo complex of formula

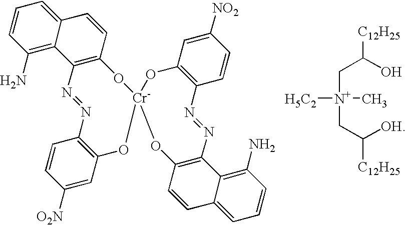

U.S. Pat. Nos. 6,168,843, 6,242,067 and JP-A-2000/198273 disclose storage media suitable for recording using a laser of wavelength 635 nm that consist of mixtures of cyanine or phthalocyanine dyes with para-amino- and nitro- or halo-substituted azo metal complexes, for example of formula

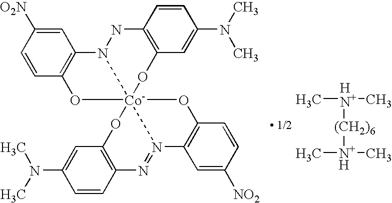

Those azo metal complexes may additionally be substituted by hydroxy. Comparison Example 2 of U.S. Pat. No. 6,242,067 discloses, however, that hydroxy substitution results in insufficient solubility. In addition, the sensitivity of compounds according to U.S. Pat. No. 6,168,843 is sufficient only for single (1×), or in the case of compounds according to U.S. Pat. No. 6,242,067 double (2×), DVD-recording speed.

U.S. Pat. No. 4,686,143 discloses writable optical Information media that can be written at 780 nm and comprise metal complexes of monoazo compounds having an aromatic ring and an N-heteroaromatic ring. The N-heteroaromatic ring may be unsubstituted or substituted by an electron acceptor substituent and both rings may be substituted by an electron donor substituent, illustrated, for example, by the ligand “NBTADMAP” of the following formula:

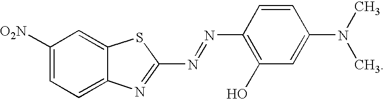

Similarly, JP-A-2002/002118 likewise discloses for use at 780 nm writable optical information media comprising metal complexes of heterocyclic azo compounds, for example those of formula

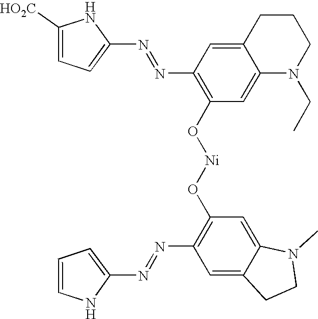

JP-A-2002/293031 proposes the combination of metal complexes from JP-A-02/55189 and JP-A-03/51182 with those of U.S. Pat. Nos. 6,168,843, 6,242,067 and JP-A-2000/198273.

A leitmotif In all those publications is that an amino group in the para-position to the azo group is necessary for good performance in optical information media.

U.S. Pat. No. 5,441,844 discloses writable optical information media comprising bisazo- or trisazo-triphenylamines, for example those of formula

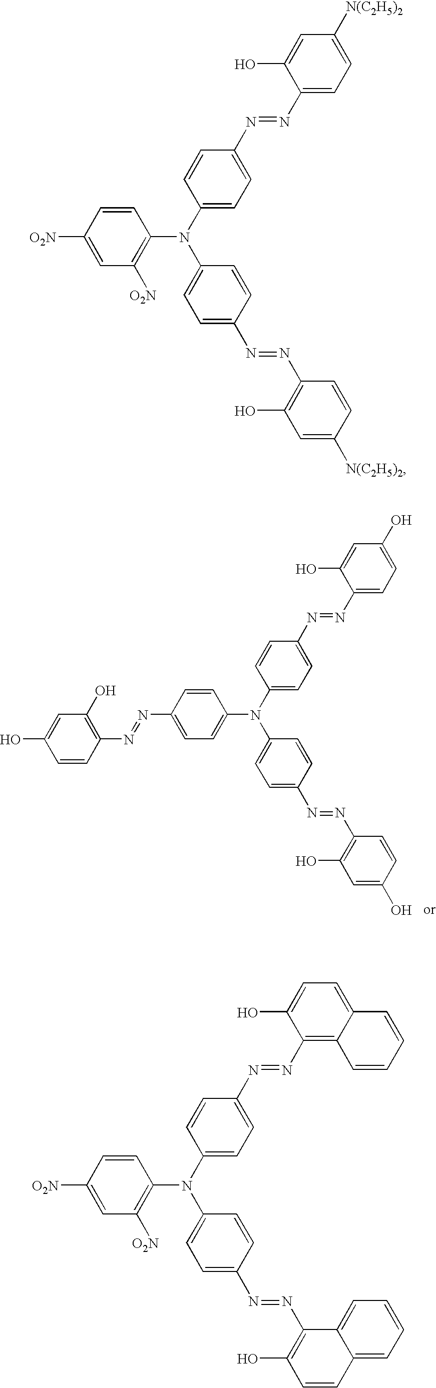

The absorption maxima λ_{MAX} are scattered very broadly from 418 to 605 nm, with molar absorption coefficients ε of from 43 000 to 126 000 (solvent not indicated).

It has been found, however, that the properties of the known recording media still leave something to be desired, especially in respect of the quality of recordings using a laser of a wavelength around 658±5 nm (DVD-R).

On the other hand, JP-A-03/132669 discloses toners for electrophotography that comprise, as an alternative to carbon black, metal complexes of formula

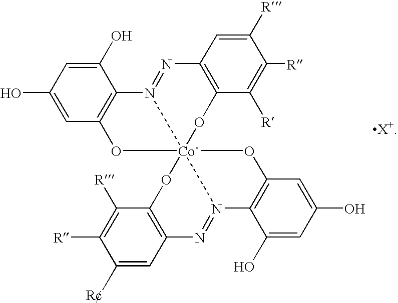

Those pulverulent, black-violet pigments are embedded in a thermoplastic plastics and as toners exhibit good stability with respect to moisture, temperature and other environmental conditions, and also full charging capacity. In the synthetic Example 3, 2-amino-5-chlorophenol is diazotised, coupled to phloroglucin and metallated with chromium acetate, the accompanying structural formula erroneously showing 2-amino-4-nitrophenol.

The non-prior-published applications WO-03/098617 and WO-03/098618 disclose pentacyclic rhodamines, in combination with which inter alia also the following anion is listed:

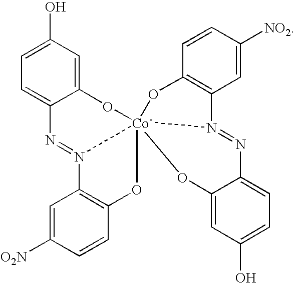

The aim of the present invention is to provide an optical recording medium, the recording layer of which has high storage capacity combined with excellent other properties. Such a recording medium should be both writable and readable at the same wavelength in the range of from 600 to 700 nm (preferably from 630 to 690 nm). The main features of the recording layer according to the invention are the very high initial reflectivity in the said wavelength range of the laser diodes, which can be modified with great sensitivity, the high refractive index; the narrow absorption band in the solid state; the good uniformity of the script width at different pulse durations; the excellent light stability, and the good solubility in polar solvents, as well as excellent compatibility with laser sources of different wavelengths both for recording and for playback.

Very surprisingly, by the use of certain metal complex anions as recording layer or as an addition to the recording layer it has been possible to provide an optical recording medium having properties that are astonishingly better than those of the recording media known hitherto. This is all the more remarkable because the metal complex anions according to the invention exhibit significantly lower extinction coefficients than known metal complex anions. In the solid layer, however, the refractive index is, quite unexpectedly, astonishingly higher. Such metal complex anions are especially interesting In combination with xanthene cations.

The invention accordingly relates to an optical recording medium comprising a substrate, a reflecting layer and a recording layer, wherein the recording layer comprises a compound of formula [L₁M^{r-4}L₂]ₒ [A^{m-}]ₚ [Zⁿ⁺]_{q} (I), [L₁M^{r-3}L₃]ₒ [A^{m-}]ₚ [Zⁿ⁺]_{q} (II) or [L₃M^{r-2}L₄]ₒ [A^{m-}]ₚ [Zⁿ⁺]_{q} (III), which compound of formula (I), (II) or (III) may also be in a mesomeric or tautomeric form, wherein

L₁ and L₂ are each Independently of the other 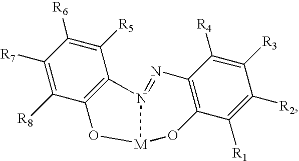
and

L₃ and L₄ are each independently of the other 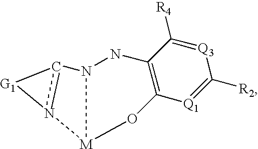
M indicating the position of M^{r-4}, M^{r-3} or M^{r-2} in (I), (I) or (III), respectively;

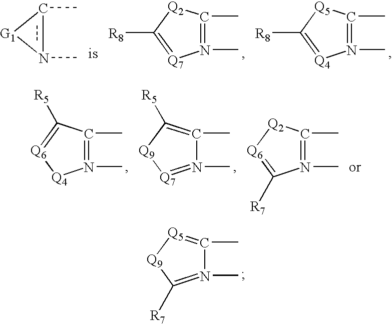

Q₁ is CR₁ or N, Q₂ is O, S, NR₁₀ or Q₅═Q₈, Q₃ is CR₃ or N, Q₄ is O, S, NR₁₀ or Q₇═Q₈, Q₅ is CR₅ or N, Q₆ is CR₆ or N, Q₇ is CR₇ or N, Q₈ is CR₈ or N, and Q₉ is O, S, NR₁₀ or Q₆═Q₈, preferably either Q₁ is CR₁ and Q₃ is CR₃ or Q₁ and Q₃ are both N, and/or Q₈ in Q₅═Q₈, Q₆═Q₈ or Q₇═Q₈ is in the β-position relative to the nitrogen atom of 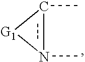
and in the case of tautomers Q₁ may also be NR₁ and/or Q₃ may also be NR₃;

R₁, R₃, R₄, R₅, R₇ and R₈ are each independently of the others H, halogen, OR₉, SR₉, NR₁₀R₁₅, NR₁₀COR₁₁, NR₁₀COOR₉, NR₁₀CONR₁₂R₁₃, NR₁₀CN, OSiR₁₀R₁₁R₁₄, COR₁₀, CR₁₀OR₁₁OR₁₄, NR₉R₁₂R₁₃⁺, NO₂, CN, CO₂⁻, COOR₉, SO₃⁻, CONR₁₂R₁₃, SO₂R₁₀, SO₂NR₁₂R₁₃, SO₃R₉, PO₃⁻, PO(OR₁₀)(OR₁₁); C₁-C₁₂alkyl, C₂-C₁₂alkenyl, C₂-C₁₂alkynyl, C₃-C₁₂cycloalkyl, C₃-C₁₂cycloalkenyl or C₃-C₁₂heterocycloalkyl each unsubstituted or mono- or poly-substituted by halogen, OR₉, SR₉, NR₁₀R₁₅, NR₁₀COR₁₁, NR₁₀COOR₉, NR₁₀CONR₁₂R₁₃, NR₁₀CN, OSiR₁₀R₁₁R₁₄, COR₁₀, CR₁₀OR₁₁OR₁₄, NR₉R₁₂R₁₃⁺, NO₂, CN, CO₂⁻, COOR₉, SO₃⁻, CONR₁₂R₁₃, SO₂R₁₀, SO₂NR₁₂R₁₃ and/or SO₃R₉; or C₇-C₁₂aralkyl, C₆-C₁₀aryl or Q₆-C₉heteroaryl each unsubstituted or mono- or poly-substituted by R₁₀, halogen, OR₉, SR₉, NR₁₀R₁₅, NR₁₀COR₁₁, NR₁₀COOR₉, NR₁₀CONR₁₂R₁₃, NR₁₀CN, OSiR₁₀R₁₁R₁₄, COR₁₀, CR₁₀OR₁₁OR₁₄, NR₉R₁₂R₁₃⁺, NO₂, CN, CO₂⁻, COOR₉, SO₃⁻, CONR₁₂R₁₃, SO₂R₁₀, SO₂NR₁₂R₁₃, SO₃R₉, PO₃⁻, PO(OR₁₀)(OR₁₁), SiR₁₀R₁₁R₁₄ and/or SiOR₁₀OR₁₁OR₁₄;

R₂ is OR₉, SR₉, NR₁₀R₁₅, NR₁₀COR₁₁, NR₁₀COOR₉, NR₁₀CONR₁₂R₁₃ or NR₁₀CN;

each R₉, independently of any other R₉, is R₁₅, COR₁₅, COOR₁₅; CONR₁₂R₁₃, CN or a negative charge, preferably H or a negative charge;

R₁₀, R₁₁, and R₁₄ are each independently of the others hydrogen, C₁-C₁₂alkyl, C₂-C₁₂alkenyl, C₂-C₁₂alkynyl, [C₂-C₈alkylene-O-]ₖ—R₁₆, [C₂-C₈alkylene-NR₁₇-]ₖ—R₁₆ or C₇-C₁₂aralkyl, it being possible for R₁₀ in NR₁₀R₁₅, NR₁₀COR₁₁, NR₁₀COOR₉, NR₁₀CONR₁₂R₁₃ or NR₁₀CN additionally to be a delocalisable negative charge;

R₁₂, R₁₃ and R₁₅ are each independently of the others H; C₁-C₁₂alkyl, C₂-C₁₂alkenyl, C₂-C₁₂alkynyl, C₃-C₁₂cycloalkyl, C₃-C₁₂cycloalkenyl or C₃-C₁₂heterocycloalkyl each unsubstituted or mono- or poly-substituted by halogen, OR₁₀, SR₁₀, NR₁₀R₁₄, NR₁₀COR₁₁, NR₁₀COOR₁₁, NR₁₀CONR₁₁R₁₄, OSiR₁₀R₁₁R₁₄, COR₁₀, CR₁₀OR₁₁OR₁₄, NR₁₀R₁₁R₁₄⁺, NO₂, CN, CO₂⁻, COOR₁₀, SO₃⁻, CONR₁₁R₁₄, SO₂NR₁₁R₁₄, SO₂R₁₀ and/or SO₃R₁₀; or C₇-C₁₂aralkyl, C₆-C₁₂aryl or C₅-C₉heteroaryl each unsubstituted or mono- or poly-substituted by R₁₀, halogen, OR₁₀, SR₁₀, NR₁₀COR₁₁, NR₁₀COOR₁₁, NR₁₀CONR₁₁R₁₄, OSiR₁₀R₁₁R₁₄, COR₁₀, CR₁₀OR₁₁OR₁₄, NR₁₀R₁₁R₁₄⁺, NO₂, CN, CO₂⁻, COOR₁₄, SO₃⁻, CONR₁₁R₁₄, SO₂R₁₀, SO₂NR₁₁R₁₄, SO₃R₁₀, PO₃⁻, PO(OR₁₀)(OR₁₁), NR₁₁R₁₄, SiR₁₀R₁₁R₁₄ and/or SiOR₁₀OR₁₁OR₁₄;

or NR₁₂R₁₃, NR₁₁R₁₄ or NR₁₀R₁₅ is a five- or six-membered heterocycle which may contain a further N or O atom and which can be mono- or poly-substituted by C₁-C₈alkyl;

R₁₆ and R₁₇ are each independently of the other mono- or poly-substituted C₁-C₁₂alkyl, C₂-C₁₂alkenyl, C₂-C₁₂alkynyl, C₃-C₁₂cycloalkyl, C₃-C₁₂cycloalkenyl, C₃-C₁₂heterocycloalkyl, C₇-C₁₂aralkyl, C₆-C₁₀aryl or C₅-C₉heteroaryl;

M^{r} is a transition metal cation having r positive charges;

A^{m-} is an inorganic, organic or organometallic anion, or a mixture thereof;

Zⁿ⁺ is a proton, a metal, ammonium or phosphonium cation, a positively charged organic or organometallic chromophore, or a mixture thereof;

it being possible once or more times radicals of the same or different ligands L₁, L₂, L₃ and/or L₄, each selected from the group consisting of R₁, R₂, R₃, R₄, R₅, R₆, R₇, R₈, R₉, R₁₀, R₁₁, R₁₂, R₁₄, R₁₅ and R₁₆, to be bonded to one another in pairs by way of a direct bond or an —O—, —S— or —N(R₁₇)— bridge, and/or for from 0 to p anions A^{m-} and/or from 0 to q cations Zⁿ⁺ each to be bonded to any radical R₁, R₂, R₃, R₄, R₅, R₆, R₇, R₈, R₉, R₁₀, R₁₁, R₁₂, R₁₃, R₁₄, R₁₅, R₁₆ or R₁₇ of the same or different ligands L₁, L₂, L₃ and/or L₄ or to M^{r} by way of a direct bond or an —O—, —S— or —N(R₁₇)— bridge;

k is an integer from 1 to 6;

m, n and r are each independently of the others an integer from 1 to 4; preferably m and n are 1 or 2 and r is 2 or 3; and

o, p and q are each a number from 0 to 4, the ratio of o, p and q to one another, according to the charge of the associated sub-structures, being such that in formula (I), (II) or (III) there is no resulting excess positive or negative charge;

and with the further proviso that when R₁, R₃, R₄, R₅, R₇ and R₈ are all H, R₂ is OH, R₆ is NO₂, M is Co and r is 3, [Zⁿ⁺]_{q} does not have the formula 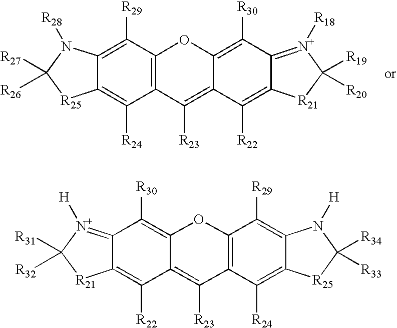
wherein R₁₈ and R₂₈ are each independently of the other hydrogen; C₁-C₂₄alkyl, C₂-C₂₄alkenyl, C₂-C₂₄alkynyl, C₃-C₂₄cycloalkyl, C₃-C₂₄cycloalkenyl or C₃-C₁₂heterocycloalkyl each unsubstituted or mono- or polysubstituted by halogen, NO₂, CN, NR₃₅R₃₆, NR₃₅R₃₆R₃₇⁺, NR₃₅COR₃₆, NR₃₅CONR₃₅R₃₆, OR₃₅, SR₃₅, COO⁻, COOH, COOR₃₅, CHO, CR₃₇OR₃₅OR₃₆, COR₃₅, SO₂R₃₅, SO₃⁻, SO₃H, SO₃R₃₅ or OSiR₃₇R₃₈R₃₉; or C₇-C₁₈aralkyl, C₆-C₁₄aryl or C₄-C₁₂heteroaryl each unsubstituted or mono- or poly-substituted by halogen, NO₂, CN, NR₃₅R₃₆, NR₃₅R₃₆R₃₇⁺, NR₃₅COR₃₆, NR₃₇CONR₃₅R₃₆, R₃₅, OR₃₅, SR₃₅, CHO, COR₃₅, CR₃₇OR₃₅OR₃₆, SO₂R₃₅, SO₃, SO₃R₃₅, SO₂NR₃₅R₃₆, COO⁻, COOR₃₅, CONR₃₅R₃₆, PO₃⁻, PO(OR₃₅)(OR₃₈), SiR₃₇R₃₈R₃₉, OSiR₃₇R₃₈R₃₉ or SiOR₃₇OR₃₈OR₃₉; but R₁₈ and R₂₈ are not simultaneously hydrogen;

R₁₉, R₂₀, R₂₈ and R₂₇ are each independently of the others C₁-C₁₂alkyl unsubstituted or mono- or poly-substituted by halogen, OR₃₇, SR₃₇, NO₂, CN, NR₄₀R₄₁, COO⁻, COOH, COOR₃₇, SO₃⁻, SO₃H or SO₃R₃₇,

it being possible for R₁₉ and R₂₀ and/or R₂₆ and R₂₇ and/or R₃₁ and R₃₂ and/or R₃₃ and R₃₄ to be so bonded to one another in pairs by way of a direct bond or an —O—, —S— or —NR₄₂— bridge that together they form a 5- to 12-membered ring;

R₂₁ and R₂₅ are each independently of the other C₁-C₃alkylene or C₁-C₃alkenylene each unsubstituted or mono- or poly-substituted by halogen, R₄₂, OR₄₂, SR₄₂, NO₂, CN, NR₄₃R₄₄, COO⁻, COOH, COOR₄₂, SO₃⁻, SO₃H or SO₃R₄₂;

R₂₂, R₂₄, R₂₉ and R₃₀ are each independently of the others hydrogen, halogen, OR₄₅, SR₄₅, NO₂, NR₄₅R₄₆; or C₁-C₂₄alkyl, C₂-C₂₄alkenyl, C₂-C₂₄alkynyl, C₃-C₂₄cycloalkyl, C₃-C₂₄cycloalkenyl, C₃-C₁₂heterocycloalkyl or C₇-C₁₈aralkyl each unsubstituted or mono- or poly-substituted by halogen, OR₄₅, SR₄₅, NO₂, CN or NR₄₅R₄₆;

R₂₃ is hydrogen; (CH₂)ₖCOO⁻, (CH₂)ₖCOOR₄₇, C₁-C₂₄alkyl, C₂-C₂₄alkenyl, C₂-C₂₄-alkynyl, C₃-C₂₄cycloalkyl or C₃-C₂₄cycloalkenyl each unsubstituted or mono- or poly-substituted by halogen, NR₄₇R₄₈ or OR₄₈; or C₇-C₁₈aralkyl, C₆-C₁₄aryl or C₅-C₁₃heteroaryl each unsubstituted or mono- or poly-substituted by halogen, NO₂, CN, NR₄₇R₄₈, SO₃⁻, SO₃R₄₇, SO₂NR₄₇R₄₈, COO⁻, (CH₂)ₖOR₄₇, (CH₂)ₖOCOR₄₇, COOR₄₇, CONR₄₇R₄₈, OR₄₇, SR₄₇, PO₃⁻, PO(OR₄₇)(OR₄₈) or SiR₃₇R₃₈R₃₉;

R₃₁, R₃₂, R₃₃ and R₃₄ are each independently of the others C₁-C₁₂alkyl unsubstituted or mono- or poly-substituted by halogen, OR₃₅, SR₃₅, NO₂, CN, NR₄₀R₄₁, COOR₃₇, SO₃⁻, SO₃H or SO₃R₃₅;

R₃₅, R₃₆, R₄₀, R₄₁, R₄₂, R₄₃, R₄₄, R₄₅, R₄₆, R₄₇ and R₄₈ are each independently of the others hydrogen; C₁-C₂₄alkyl, C₂-C₂₄alkenyl, C₂-C₂₄alkynyl, C₃-C₂₄cycloalkyl, C₃-C₂₄cycloalkenyl or C₃-C₁₂heterocycloalkyl each unsubstituted or mono- or poly-substituted by halogen, NO₂, CN, NR₃₇R_{38,} NR₃₇R₃₈R₃₉⁺, NR₃₇COR₃₈, NR₃₇CONR₃₈R₃₉, OR₃₇, SR₃₇, COO⁻, COOH, COOR₃₇, CHO, CR₃₇OR₃₈OR₃₉, COR₃₇, SO₂R₃₇, SO₃⁻, SO₃H, SO₃R₃₇ or OSiR₃₇R₃₈R₃₉; or C₇-C₁₈aralkyl, C₆-C₁₄aryl or C₅-C₁₃heteroaryl each unsubstituted or mono- or poly-substituted by halogen, NO₂, CN, NR₃₇R₃₈, NR₃₇R₃₈R₃₉⁺, NR₃₇COR₃₈, NR₃₇CONR₃₈R₃₉, R₃₇, OR₃₇, SR₃₇, CHO, CR₃₇OR₃₈OR₃₉, COR₃₇, SO₂R₃₇, SO₃⁻, SO₂NR₃₇R₃₈, COO⁻, COOR₃₉, CONR₃₇R₃₈, PO₃⁻, PO(OR₃₇)(OR₃₈), SiR₃₇R₃₈R₃₉, OSiR₃₇R₃₈R₃₉ or SiO_{R}₃₇OR₃₈OR₃₉;

or NR₃₅R₃₆ NR₄₀R₄₁, NR₄₃R₄₄, NR₄₅R₄₆ or NR₄₇R₄₈ are a five- or six-membered heterocycle which may contain a further N or O atom and which can be mono- or poly-substituted by C₁-C₈alkyl;

R₃₇, R₃₈ and R₃₉ are each independently of the others hydrogen, C₁-C₂₀alkyl, C₂-C₂₀alkenyl, C₂-C₂₀alkynyl or C₇-C₁₈aralkyl, it being possible for R₃₇ and R₃₈ to be bonded to one another by way of a direct bond or an —O—, —S— or —NC₁-C₈alkyl-bridge so that together they form a five- or six-membered ring;

it being possible for from 1 to 4 radicals selected from the group consisting of R₁₈, R₁₉, R₂₁, R₂₂, R₂₃, R₂₄, R₂₅, R₂₆, R₂₈, R₂₉, R₃₀, R₃₅, R₃₆, R₃₇, R₃₈, R₃₉, R₄₀, R₄₁, R₄₂, R₄₃, R₄₄, R₄₅, R₄₆, R₄₇ and R₄₈ to be bonded to one another in pairs by way of a direct bond or an —O—, —S— or —N(G)— bridge or bonded singly to A^{m-} and/or Zⁿ⁺, wherein G is mono- or poly-substituted C₁-C₂₄alkyl, C₂-C₂₄alkenyl, C₂-C₂₄alkynyl, C₃-C₂₄cycloalkyl, C₃-C₂₄cycloalkenyl, C₃-C₁₂heterocycloalkyl, C₇-C₁₈aralkyl, C₆-C₁₄aryl or C₅-C₁₃heteroaryl.

Q₅═Q₈, Q₆═Q₈ or Q₇═Q₈ each denote two atoms or groups in accordance with the definitions of Q₅, Q₆, Q₇ and Q₈ joined by a double bond.

Advantageously, p and q are not simultaneously numbers 1 to 4, but either p or q is 0. Preferably, p is 0 and q is from 1 to 4, especially 1. When the numbers p and q are not whole numbers, formula (I), (II) or (III) is to be interpreted as being a mixture of a certain molar composition in which the individual components may also have different stoichiometry.

Transition metal cations are, for example, Co²⁺, Co³⁺, Cu⁺, Cu²⁺, Zn²⁺, Cr³⁺, Ni²⁺, Fe²⁺, Fe³⁺, Al³⁺, Ce²⁺, Ce³⁺, Mn²⁺, Mn³⁺, Si⁴⁺, Ti⁴⁺, V³⁺, V⁵⁺ or Zr⁴⁺, preferably Co²⁺, Co³⁺, Cr³⁺, Ni²⁺, Fe³⁺ or Si⁴⁺.

Anions are, for example, hydroxide, oxide, fluoride, chloride, bromide, iodide, perchlorate, periodate, carbonate, hydrogen carbonate, sulfate, hydrogen sulfate, phosphate, hydrogen phosphate, dihydrogen phosphate, tetrafluoroborate, hexafluoroantimonate, acetate, oxalate, methanesulfonate, trifluoromethanesulfonate, tosylate, methyl sulfate, phenolate, benzoate or a negatively charged metal complex. Metal, ammonium or phosphonium cations are, for example, Li⁺, Na⁺, K⁺, Mg²⁺, Ca²⁺, Cu²⁺, Ni²⁺, Fe²⁺, Fe²⁺, Co²⁺, Co³⁺, Zn²⁺, Sn²⁺, Cr³⁺, La³⁺, methylammonium, ethylammonium, pentadecylammonium, isopropylammonium, dicyclohexylammonium, tetramethylammonium, tetraethylammonium, tetrabutylammonium, benzylbimethylammonium, benzyltriethylammonium, methyltrioctylammonium, tridodecylmethylammonium, tetrabutylphosphonium, tetraphenylphosphonium, butyltriphenylphosphonium or ethyltriphenylphosphonium, or protonated Primene 81R™ or Rosin Amine D™. Preference is given to H, Na⁺, K⁺, NH₄⁺, primary, secondary, tertiary or quaternary ammonium and also to cationic chromophores.

As positively charged organic chromophores there may be used any cations that absorb in the range of from 300 to 1500 nm, especially in the range of from 300 to 800 nm. The person skilled in the art will preferably select especially chromophore cations that have already been previously proposed for use in optical information media, for example cyanine, xanthene, dipyrromethene, styryl, triphenylmethine, azo, metal complex, quinone diimmonium, bipyridinium and other cations. Cyanine, xanthene, dipyrromethene, azo metal complex and styryl cations are preferred. Further chromophores suitable for use in cationic form can be found in WO-01/75873, but those examples are on no account to be regarded as a limiting selection.

Alkyl, alkenyl or alkynyl may be straight-chain or branched. Alkenyl is alkyl that is mono- or poly-unsaturated, wherein two or more double bonds may be isolated or conjugated. Alkynyl is alkyl or alkenyl that is doubly-unsaturated one or more times, wherein the triple bonds may be isolated or conjugated with one another or with double bonds. Cycloalkyl or cycloalkenyl is monocyclic or polycyclic alkyl or alkenyl, respectively.

C₁-C₂₄Alkyl can therefore be, for example, methyl, ethyl, n-propyl, isopropyl, n-butyl, sec-butyl, isobutyl, tertbutyl, 2-methyl-butyl, n-pentyl, 2-pentyl, 3-pentyl, 2,2-dimethylpropyl, n-hexyl, heptyl, n-octyl, 1,1,3,3-tetramethylbutyl, 2-ethylhexyl, nonyl, decyl, undecyl, dodecyl, tridecyl, tetradecyl, pentadecyl, hexadecyl, heptadecyl, octadecyl, nonadecyl, eicosyl, heneicosyl, docosyl or tetracosyl.

C₃-C₂₄Cycloalkyl can therefore be, for example, cyclopropyl, cyclopropyl-methyl, cyclobutyl, cyclopentyl, cyclohexyl, cyclohexyl-methyl, trimethylcyclohexyl, thujyl, norbornyl, bornyl, norcaryl, caryl, menthyl, norpinyl, pinyl, 1-adamantyl, 2-adamantyl, 5α-gonyl or 5ξ-pregnyl.

C₂-C₂₄Alkenyl is, for example, vinyl, allyl, 2-propen-2-yl, 2-buten-1-yl, 3-buten-1-yl, 1,3-butadien-2-yl, 2-penten-1-yl, 3-penten-2-yl, 2-methyl-1-buten-3-yl, 2-methyl-3-buten-2-yl, 3-methyl-2-buten-1-yl, 1,4-pentadien-3-yl, or any isomer of hexenyl, octenyl, nonenyl, decenyl, dodecenyl, tetradecenyl, hexadecenyl, octadecenyl, elcosenyl, heneicosenyl, docosenyl, tetracosenyl, hexadienyl, octadienyl, nonadienyl, decadienyl, dodecadienyl, tetradecadienyl, hexadecadienyl, octadecadienyl or eicosadienyl.

C₃-C₂₄Cycloalkenyl is, for example, 2-cyclobuten-1-yl, 2-cyclopenten-1-yl, 2-cyclohexen-1-yl, 3-cyclohexen-1-yl, 2,4-cyclohexadien-1-yl, 1-p-menthen-8-yl, 4(10)-thujen-10-yl, 2-norbornen-1-yl, 2,5-norbornadien-1-yl, 7,7-dimethyl-2,4-norcaradien-3-yl or camphenyl.

C₂-C₂₄Alkynyl is, for example, 1-propyn-3-yl, 1-butyn-4-yl, 1-pentyn-5-yl, 2-methyl-3-butyn-2-yl, 1,4-pentadiyn-3-yl, 1,3-pentadiyn-5-yl, 1-hexyn-6-yl, cis-3-methyl-2-penten-4-yn-1-yl, trans-3-methyl-2-penten-4-yn-1-yl, 1,3-hexadiyn-5-yl, 1-octyn-8-yl, 1-nonyn-9-yl, 1-decyn-10-yl or 1-tetracosyn-24-yl.

C₇-C₂₄Aralkyl is, for example, benzyl, 2-benzyl-2-propyl, β-phenyl-ethyl, 9-fluorenyl, α,α-dimethylbenzyl, ω-phenyl-butyl, ω-phenyl-octyl, ω-phenyl-dodecyl or 3-methyl-5-(1′,1′,3′,3′-tetramethyl-butyl)-benzyl. C₇-C₂₄Aralkyl can also be, for example, 2,4,6-tri-tert-butyl-benzyl or 1-(3,5-dibenzyl-phenyl)-3-methyl-2-propyl. When C₇-C₂₄aralkyl is substituted, both the alkyl moiety and the aryl moiety of the aralkyl group can be substituted, the latter alternative being preferred.

C₆-C₂₄Aryl is, for example, phenyl, naphthyl, biphenylyl, 2-fluorenyl, phenanthryl, anthracenyl or terphenylyl.

Halogen is chlorine, bromine, fluorine or iodine, preferably chlorine or bromine.

C₄-C₁₂Heteroaryl is an unsaturated or aromatic radical having 4n+2 conjugated π-electrons, for example 2-thienyl, 2-furyl, 1-pyrazolyl, 2-pyridyl, 2-thiazolyl, 2-oxazolyl, 2-imidazolyl, isothiazolyl, triazolyl or any other ring system consisting of thiophene, furan, pyridine, thiazole, oxazole, imidazole, isothiazole, thiadiazole, triazole, pyridine and benzene rings and unsubstituted or substituted by from 1 to 6 ethyl, methyl, ethylene and/or methylene substituents.

Furthermore, aryl and aralkyl can also be aromatic groups bonded to a metal, for example in the form of metallocenes of transition metals known per se, more especially 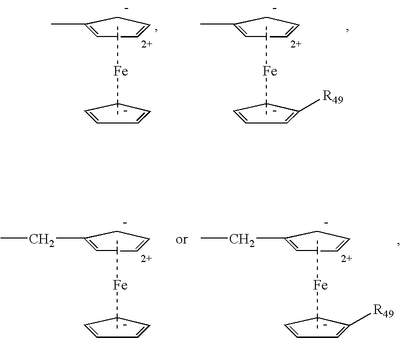
wherein R₄₉ is CH₂OH, CH₂OR₁₅ or COOR₁₅.

C₃-C₁₂Heterocycloalkyl is an unsaturated or partially unsaturated ring system radical, for example epoxy, oxetan, aziridine; tetrazolyl, pyrrolidyl, piperidyl, piperazinyl, imidazolinyl, pyrazolidinyl, pyrazolinyl, morpholinyl, quinuclidinyl; or some other C₄-C₁₂heteroaryl that is mono- or poly-hydrogenated.

5- to 12-membered rings are, for example, cyclopentyl, cyclohexyl, cycloheptyl and cyclooctyl, preferably cyclopentyl and especially cyclohexyl.

Especially the following substituents may be mentioned as R₁ to R₁₇: —CH₂—CH₂—OH, —CH₂—O—CH₃, —CH₂—O—(CH₂)₇—CH₃, —CH₂—CH₂—O—CH₂—CH₃, —CH₂—CH(OCH₃)₂, —CH₂—CH₂—CH(OCH₃)₂, —CH₂—C(OCH₃)₂—CH₃, —CH₂—CH₂—O—CH₂—CH₂—O—CH₃, —(CH₂)₃—OH, —(CH₂)₈—OH, —(CH₂)₇—OH, —(CH₂)₈—OH, —(CH₂)₉—OH, —(CH₂)₁₀—OH, —CH₂)₁₁—OH, —(CH₂)₁₂—OH, —CH₂—Si(CH₃)₃, —CH₂—CH₂—O—Si(CH₃)₂—C(CH₃)₃, —(CH₂)₃—O—Si(CH₃)₂—C(CH₃)₃, —(CH₂)₄—O—Si(C₆H₅)₂—C(CH₃)₃, —CH₂—CH₂—CH(CH₃)—CH₂—CH₂—CH(OH)—C(CH₃)₂—OH, —(CH₂)₅—O—Si(CH(CH₃)₂)₃, —CH₂—CH(CH₃)—CH₂—OH, —CH₂—C(CH₃)₂—CH₂—OH, —CH₂—C(CH₂—OH)₃, —CH₂—CH(OH)—CH₃, —CH₂—CH(OH)—CH₂—OH, 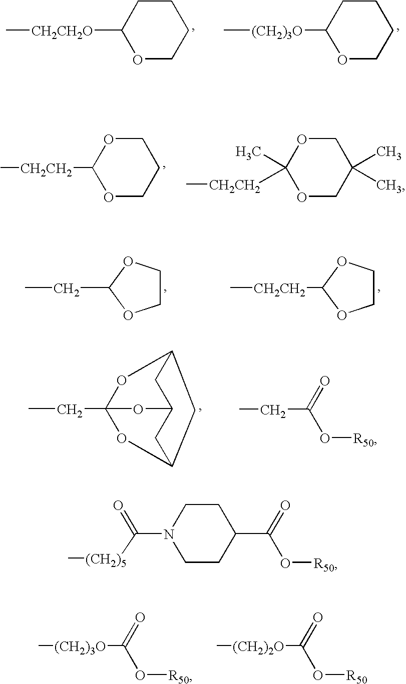 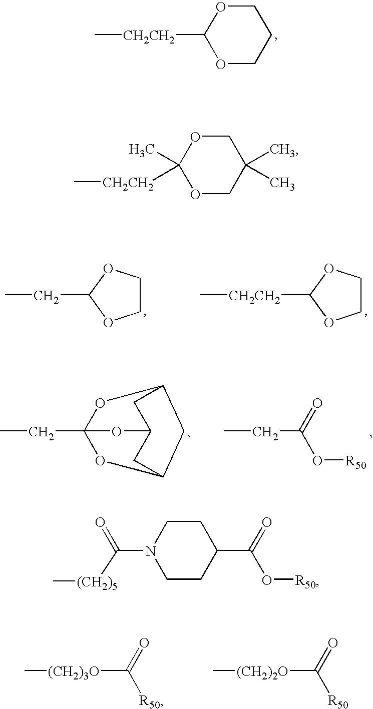
and —(CH₂)₂CH═N—R₅₀, wherein R₅₀ is C₁-C₁₂alkyl, C₂-C₁₂alkenyl, C₂-C₁₂alkynyl, C₃-C₁₂cycloalkyl, C₃-C₁₂cycloalkenyl, C₇-C₁₂aralkyl, C₆-C₁₂aryl, C₄-C₁₂heteroaryl, C₃-C₁₂heterocycloalkyl each unsubstituted or substituted by one or more identical or different radicals in accordance with the definitions given above, or is a metal complex When R₅₀ is C₁-C₁₂alkyl, it may be uninterrupted or interrupted by from 1 to 3 oxygen and/or silicon atoms. Especially advantageous is alkyl that is unsubstituted or substituted by one or two hydroxy substituents or by a metallocenyl or azo metal complex radical especially methyl, ethyl, n-propyl, isopropyl, n-butyl, 2-butyl, isobutyl, tert-butyl, 3-pentyl, n-amyl, tert-amyl, neopentyl, 2,2-dimethyl-but-4-yl, 2,2,4-trimethyl-pent-5-yl, cyclopropyl, cyclopropylmethyl, cyclobutyl, cyclobutylmethyl, cyclopentyl, cyclopentylmethyl, cyclohexyl, cyclohexylmethyl, cyclohex-4-enyl-methyl, 5-methyl-cyclohex-4-enyl-methyl or 2-ethyl-hexyl. Those radicals are of very special importance as R₉ or R₁₅.

R₂ is preferably OR₉, SR₉ or NR₁₀CN, especially preferred OR₉, particularly wherein R₉ and R₁₀ are negative charges which, especially advantageously in formula (II), lead to additional bonds with the metal in the mesomeric form. It is especially preferred that, either in combination with preferred R₂ or independently thereof, at least one of R₅, R₆, R₇ and R₈ is CF₃, COR₁₀, CR₁₀OR₁₁OR₁₄, NR₉R₁₂R₁₃⁺, NO₂, CN, CO₂⁻, COOR₉, SO₃⁻, CONR₁₂R₁₃, SO₂R₁₀, SO₂NR₁₂R₁₃, SO₃R₉, PO₃⁻ or PO(OR₁₀)(OR₁₁); especially R₆ or R₇ is CF₃, NR₉R₁₂R₁₃⁺, NO₂, CN, CO₂⁻, COOR₉, SO₃⁻ or SO₃R₉.

The recording medium according to the invention, in addition to comprising the compounds of formula (I), (II) or (III), may additionally comprise salts, for example ammonium chloride, pentadecylammonium chloride, cobalt(II) chloride, sodium chloride, sodium sulfate, sodium methylsulfonate or sodium methyl sulfate, the ions of which may, for example, originate from the components used.

Preference is given to compounds of formula (I), (II) or (III) wherein R₂ and R₄ are hydroxy, O⁻, mercapto or S⁻ and R₆ or R₇ is nitro or cyano; Zⁿ⁺ is a xanthene; and/or R₁₀ is methyl, ethyl, n-propyl, isopropyl, n-butyl, 2-butyl, isobutyl, tert-butyl, 3-pentyl, n-amyl, tert-amyl, neopentyl, 2,2-dimethyl-but-4-yl, 2,2,4-trimethyl-pent-5-yl, cyclopropyl, cyclopropylmethyl, cyclobutyl, cyclobutylmethyl, cyclopentyl, cyclopentylmethyl, cyclohexyl, cyclohexylmethyl, cyclohex-4-enyl-methyl, 5-methylcyclohex-4-enyl-methyl or 2-ethyl-hexyl, each unsubstituted or mono- or poly-substituted by fluorine.

Special preference is given to compounds of formula (I), (II) or (III) wherein R₂ and R₄ are hydroxy or O⁻ and/or R₆ or R₇ is nitro. C₁-C₁₂Alkyl, C₂-C₁₂alkenyl, C₂-C₁₂alkynyl, C₃-C₁₂cycloalkyl, C₃-C₁₂cycloalkenyl, C₃-C₁₂heterocycloalkyl, C₇-C₁₂aralkyl, C₆-C₁₀aryl and C₅-C₉heteroaryl are generally preferably C₁-C₈alkyl, C₂-C₈alkenyl, C₂-C₈alkynyl, C₃-C₈cycloalkyl, C₃-C₈cycloalkenyl, C₃-C₈heterocycloalkyl, C₇-C₈alkyl, phenyl and C₅-heteroaryl, especially C₁-C₄alkyl, C₂-C₄alkenyl, C₂-C₄alkynyl, C₃-C₄cycloalkyl, C₃-C₄cycloalkenyl and C₃-C₄heterocycloalkyl.

When R₁₀ and R₁₁ are bonded to one another by way of a direct bond or an —O—, —S— or —NR₁₇— bridge, they are preferably so bonded that a five- or six-membered ring is formed.

Those preferences apply to each of the sub-structures contained in formula (I), (II) or (III), in each case independently of any other sub-structures which may be present, provided that the condition inherent in formula (I), (II) or (III) is fulfilled, i.e. that the resulting compound does not have an excess positive or negative charge. Sub-structures of formula (I), (II) or (III) are to be understood as being their three components [metal complex⁻⁴]₀, (A^{m-})ₚ and (Zⁿ⁺)_{q}, which, as indicated above, may be bonded to one another. As will be seen from the definition given above, the sub-structures may be bonded to one another or a plurality of identical or different sub-structures may be, for example, in the form of dimers. Examples of M^{r+} and A^{m-} bonded to one another are (but are by no means exclusively) Fe(OH)²⁺, Fe(Cl)²⁺, Ti(O)²⁺ and V(O)³⁺.

Preference is given also to metal complexes wherein two ligands of formula (I), (II) or (III) are bridged, for example by way of direct bonds or —O—, —S— or —NR₁₇— bridges between any substituents in formula (I), (II) or (III), it being possible for the bridged ligands L₁ and L₂, L₁ and L₃ or L₃ and L₄ to be complexed either with the same metal cation or optionally with different metal cations, there being formed in the latter case oligomers which are, of course, also to be regarded as being subjects of the invention. Bridgings by way of N atoms of L₁, L₂, L₃ or L₄, either those in the chromophore or those on substituents, are especially advantageous. Such oligomer formation is illustrated by the following example (which is on no account limiting) wherein X may be, for example, —CH₂—, —CH₂—CH₂—, —CH₂—O—CH₂— or —CH₂—NH—CH₂—:

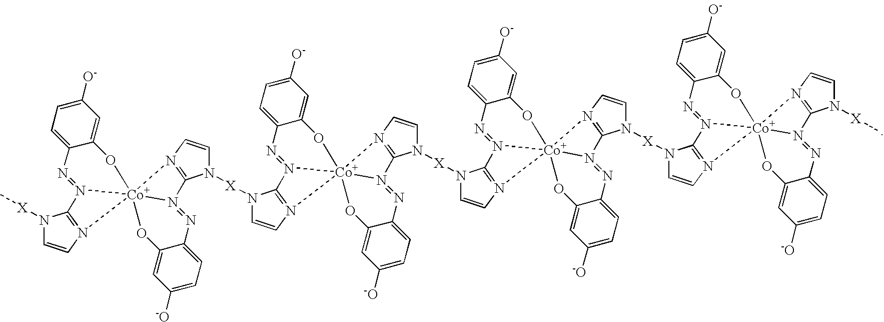

The preparation of such and similar oligomers is known to the person skilled in the art.

For example, compounds of formula (I), (II) or (III) may contain as xanthene sub-structures cations that are claimed or disclosed in U.S. Pat. No. 5,851,621. Special preference is given to all the xanthene cations claimed or disclosed in WO-03/098617 and WO-03/098618, the teaching of which is expressly referred to here.

Special preference is given also to compounds of formula (I), (II) or (III) wherein n, o and q are the number 1, p is the number 0, and r is 2 or 3.

Interesting compounds of formula (I) are especially those of formulae

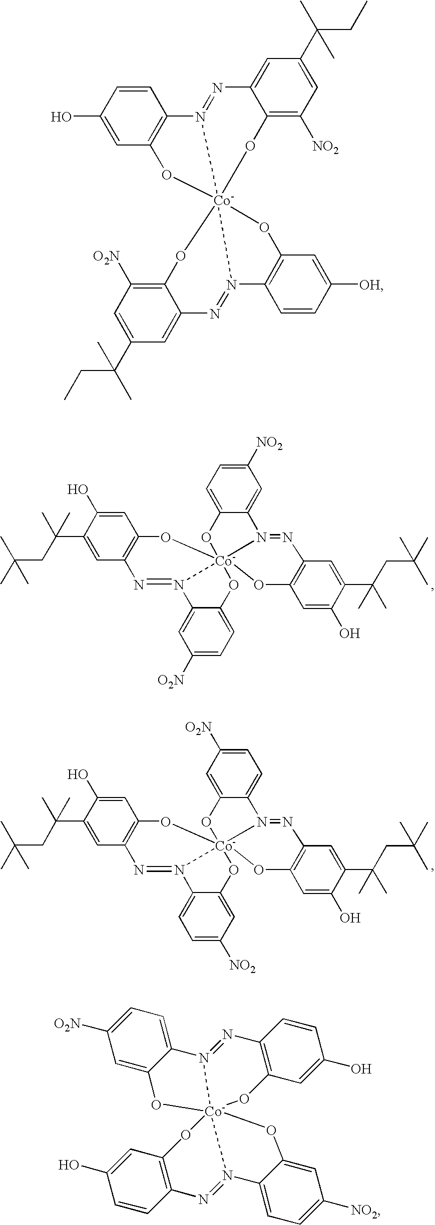

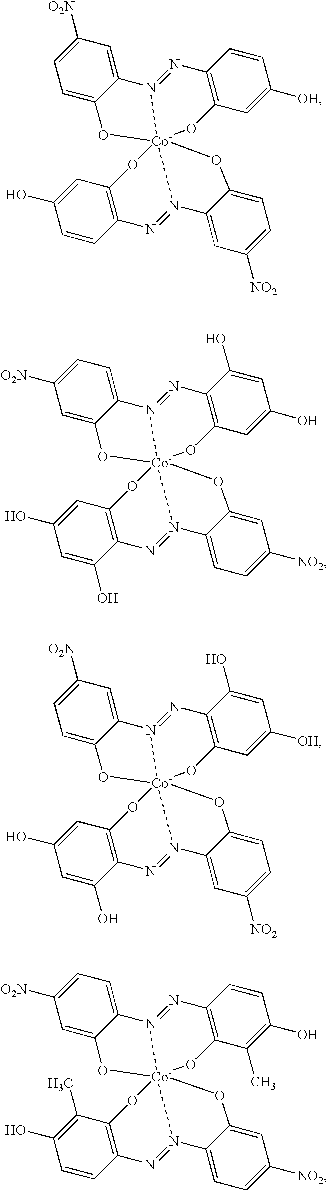

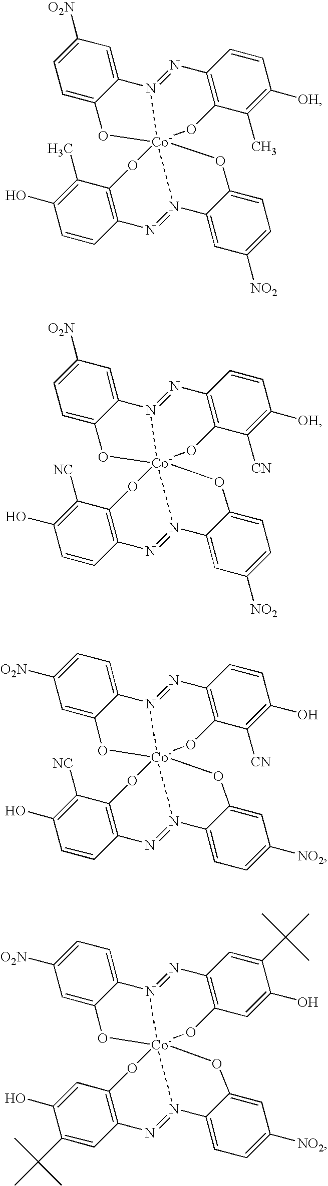

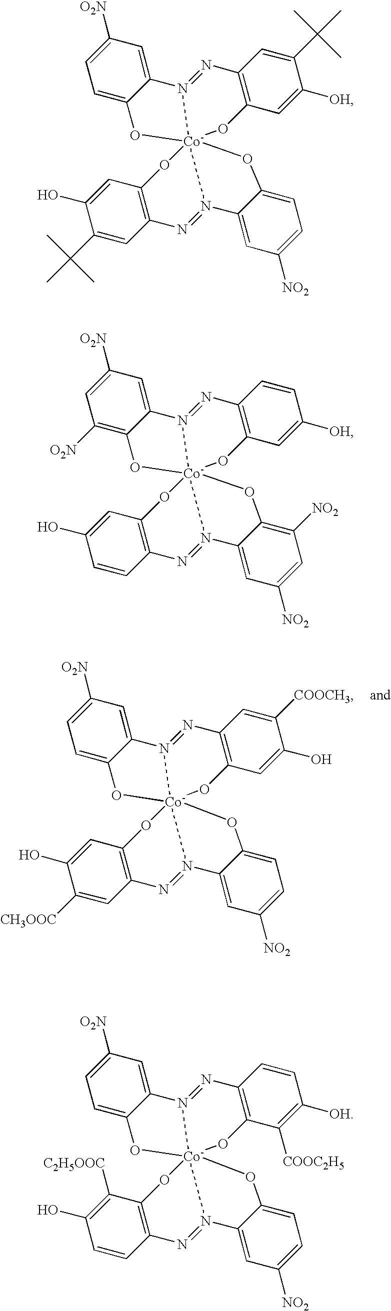

Interesting compounds of formula (III) are especially those of formulae

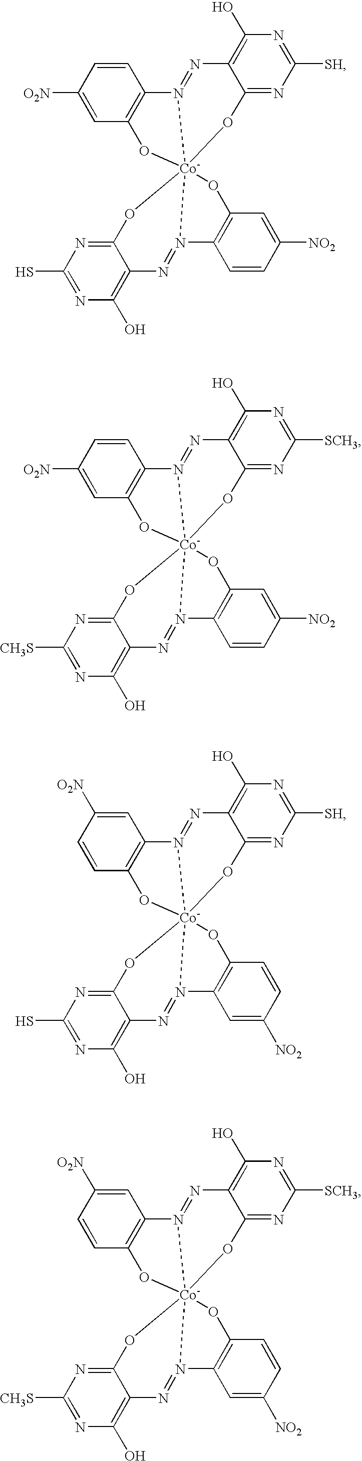

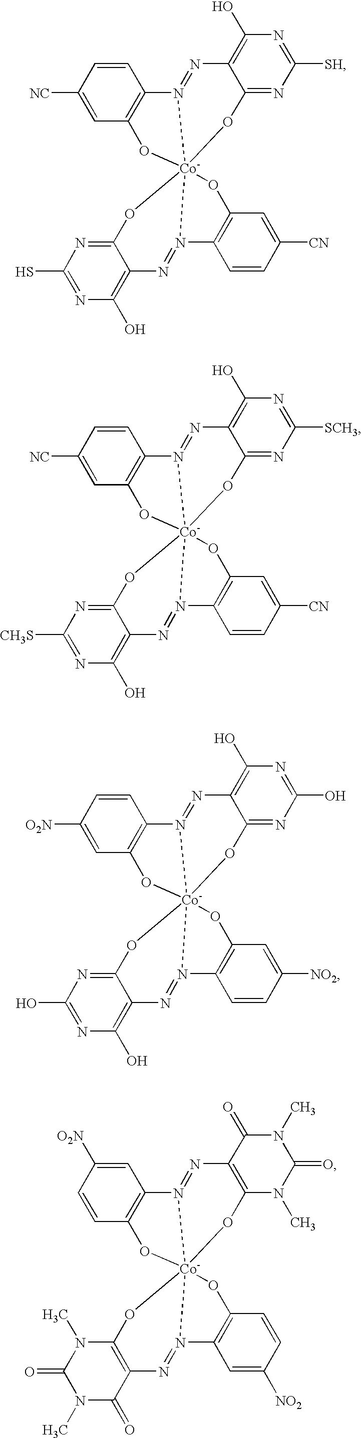

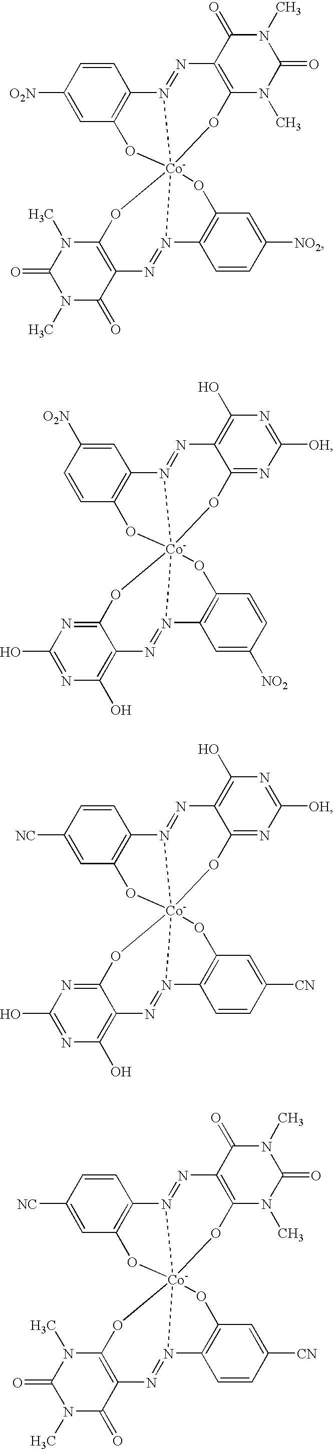

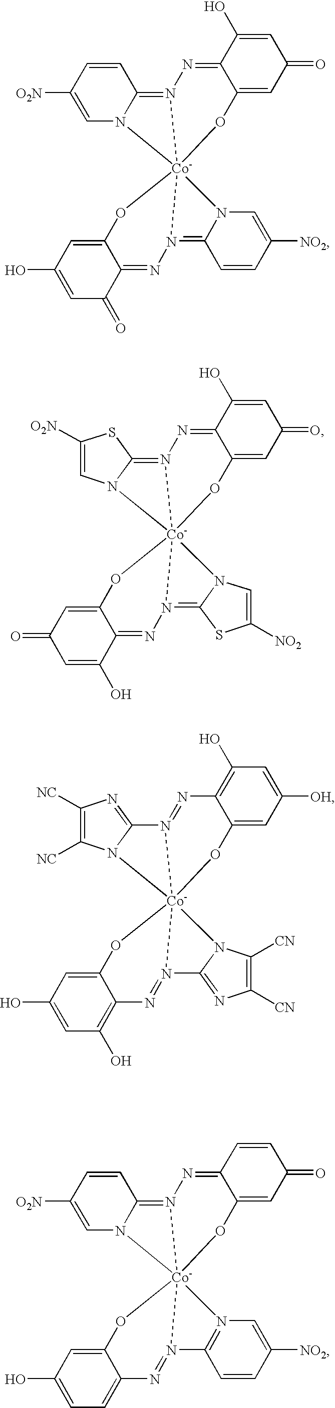

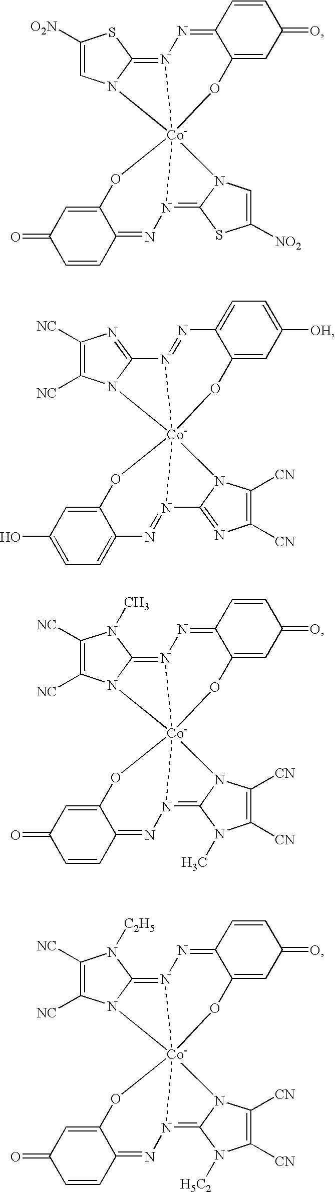

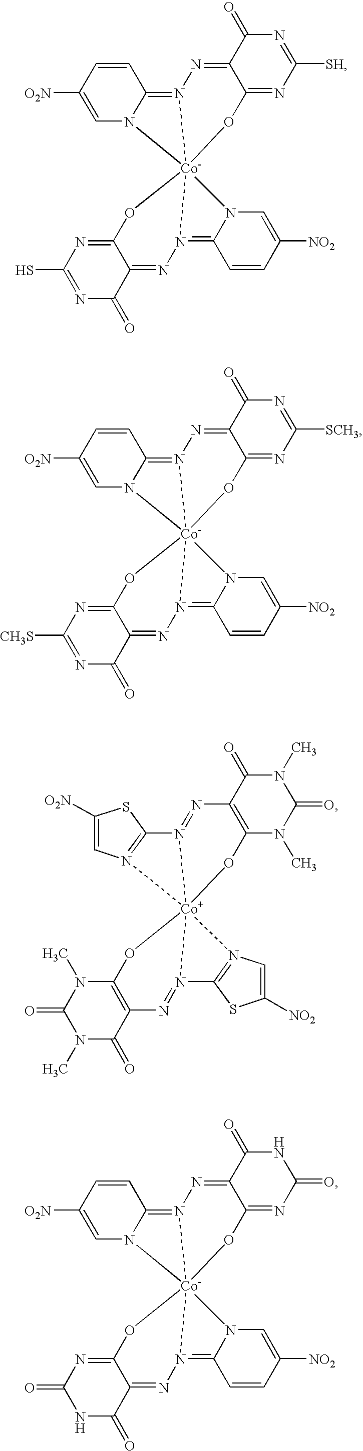

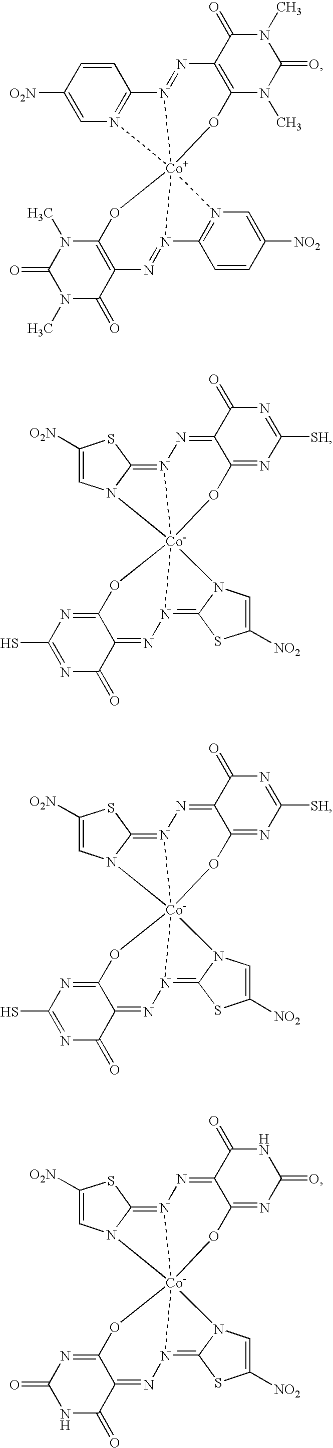

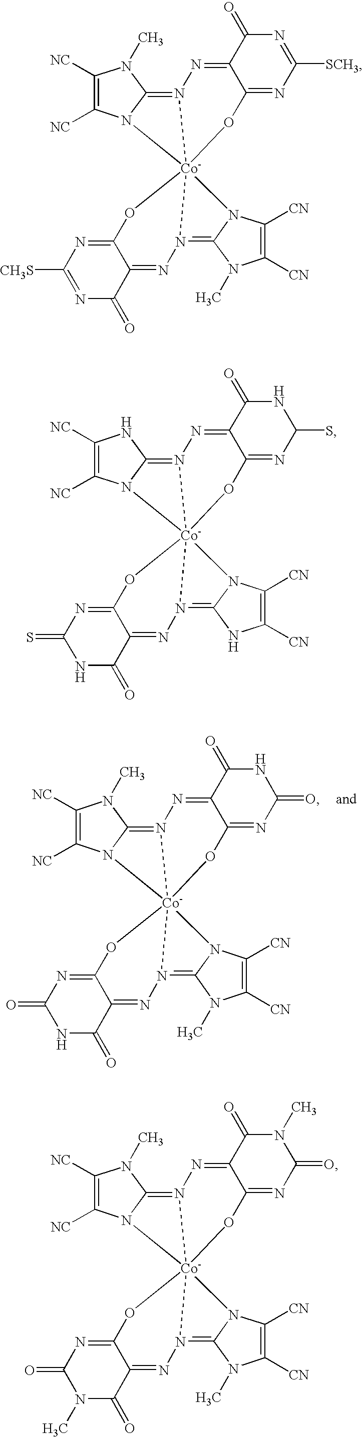

Interesting compounds of formula (II) are especially those having sub-structures of formulae (I) and (III). They may be prepared simply by mixed synthesis, ligands L₁ and L₃ being metallated at the same time. The compounds of formula (II) can be isolated by customary methods or preferably used in admixture with compounds of formulae (I) and (III).

Some of the compounds of formula (I), (II) or (III) are known compounds. Those compounds which are novel can be prepared analogously to the known compounds by methods known per se.

The metal complexes used according to the invention have, in solid form, a surprisingly extremely narrow absorption band.

The substrate, which acts as support for the layers applied thereto, is advantageously semi-transparent (T≧10%) or preferably transparent (T≧90%). The support can be from 0.01 to 10 mm thick, preferably from 0.1 to 5 mm thick.

The recording layer is preferably arranged between the transparent substrate and the reflecting layer. The thickness of the recording layer is from 10 to 1000 nm, preferably from 30 to 300 nm, especially about 80 nm, for example from 60 to 120 nm. The absorption of the recording layer is typically from 0.1 to 1.0 at the absorption maximum. The layer thickness is very especially so chosen in known manner in dependence upon the respective refractive indices in the non-written state and in the written state at the reading wavelength that in the non-written state constructive interference is obtained, but in the written state destructive interference is obtained, or vice versa.

The reflecting layer, the thickness of which can be from 10 to 150 nm, preferably has high reflectivity (R≧45%, especially R≧60%), coupled with low transparency (T≦10%). In further embodiments, for example in the case of media having a plurality of recording layers, the reflector layer may likewise be semi-transparent, that is to say may have comparatively high transparency (for example T≧50%) and low reflectivity (for example R≦30%).

The uppermost layer, for example the reflective layer or the recording layer, depending upon the layer structure, is advantageously additionally provided with a protective layer having a thickness of from 0.1 to 1000 μm, preferably from 0.1 to 50 μm, especially from 0.5 to 15 μm. Such a protective layer can, if desired, serve also as adhesion promoter for a second substrate layer applied thereto, which is preferably from 0.1 to 5 mm thick and consists of the same material as the support substrate.

The reflectivity of the entire recording medium is preferably at least 15%, especially at least 40%.

The main features of the recording layer according to the invention are the very high initial reflectivity in the said wavelength range of the laser diodes, which can be modified with great sensitivity; the high refractive index; the especially narrow absorption band in the solid state; the good uniformity of the script width at different pulse durations; as well the good light stability and the good solubility in polar solvents.

The recording medium according to the invention is neither writable nor readable using the infra-red laser diodes of customary CD apparatus in accordance with the requirements of the Orange Book Standard. As a result, the risk of damage in the event of an erroneous attempt at writing using an apparatus not capable of high resolution is largely averted, which is of advantage. The use of dyes of formula (I), (II) or (III) results in advantageously homogeneous, amorphous and low-scatter recording layers having a high refractive index, and the absorption edge is surprisingly especially steep even in the solid phase. Further advantages are high light stability in daylight and under laser radiation of low power density with, at the same time, high sensitivity under laser radiation of high power density, uniform script width, high contrast, and also good thermal stability and storage stability.

At a relatively high recording speed, the results obtained are surprisingly better than with previously known recording media. The marks are more precisely defined relative to the surrounding medium, and thermally induced deformations do not occur. The error rate (BLER) and the statistical variations in mark lengths (jitter) are also low both at normal recording speed and at elevated recording speed, so that an error-free recording and playback can be achieved over a wide range of speeds. There are virtually no rejects even at high recording speed, and the reading of written media is not slowed down by the correction of errors. The advantages are obtained over the entire range from 600 to 700 nm (preferably from 630 to 690 nm), but are especially marked at from 640 to 680 nm, more especially from 650 to 670 nm, particularly at 658±5 nm.

Suitable substrates are, for example, glass, minerals, ceramics and thermosetting or thermoplastic plastics. Preferred supports are glass and homo- or co-polymeric plastics. Suitable plastics are, for example, thermoplastic polycarbonates, polyamides, polyesters, polyacrylates and polymethacrylates, polyurethanes, polyolefins, polyvinyl chloride, polyvinylidene fluoride, polyimides, thermosetting polyesters and epoxy resins. The substrate can be in pure form or may also comprise customary additives, for example UV absorbers or dyes, as proposed e.g. in JP 04/167 239 to provide light-stabilisation for the recording layer. In the latter case it may be advantageous for the dye added to the support substrate to have an absorption maximum hypsochromically shifted relative to the dye of the recording layer by at least 10 nm, preferably by at least 20 nm.

The substrate is advantageously transparent over at least a portion of the range from 600 to 700 nm (preferably as indicated above), so that it is permeable to at least 90% of the incident light of the writing or readout wavelength. The substrate has preferably on the coating side a spiral guide groove having a groove depth of from 50 to 500 nm, a groove width of from 0.2 to 0.8 μm and a track pitch between two turns of from 0.4 to 1.6 μm, especially having a groove depth of from 100 to 200 nm, a groove width of 0.3 μm and a pitch between two turns of from 0.6 to 0.8 μm. The recording layer is advantageously of different thickness in and outside the groove, depending upon the depth of the groove; the thickness of the recording layer in the groove is usually about from 2 to 20× greater than outside, typically 5-10× greater in the groove than outside. The recording layer can also be present exclusively in the groove.

The storage media according to the invention are therefore suitable especially advantageously for the optical recording of DVD media having the currently customary minimum pit length of 0.4 μm and track pitch of 0.74 μm. The increased recording speed relative to known media allows synchronous recording or, for special effects, even accelerated recording of video sequences with excellent image quality.

The recording layer, instead of comprising a single compound of formula (I), (II) or (III), may alternatively comprise a mixture of such compounds having, for example, 2, 3, 4 or 5 metal azo dyes according to the invention. By the use of mixtures, for example mixtures of isomers or homologues as well as mixtures of different structures, often the solubility can be increased and/or the amorphous content improved. If desired, mixtures of ion, pair compounds may have different anions, different cations or both different anions and different cations.

For a further increase in stability it is also possible, if desired, to add known stabilisers in customary amounts, for example a nickel dithiolate described in JP 04/025 493 as light stabiliser.

The recording layer comprises a compound of formula (I), (II) or (III) or a mixture of such compounds advantageously in an amount sufficient to have a substantial influence on the refractive index, for example at least 10% by weight, preferably at least from 30 to 70% by weight, especially at least from 40 to 60% by weight The recording layer can especially valuably comprise a compound of formula (I), (II) or (III) or a mixture of a plurality of such compounds as main component, or may consist exclusively or substantially of one or more compounds of formula (I), (II) or (III).

Further customary constituents are possible, for example other chromophores (for example those having an absorption maximum at from 300 to 1000 nm), UV absorbers and/or other stabilisers, ¹O₂-, triplet- or luminescence-quenchers, melting-point reducers, decomposition accelerators or any other additives that have already been described in optical recording media, for example film-formers.

When the recording layer comprises further chromophores, such chromophores may in principle be any dyes that can be decomposed or modified by the laser radiation during the recording, or they may be inert towards the laser radiation. When the further chromophores are decomposed or modified by the laser radiation, this can take place directly by absorption of the laser radiation or can be induced indirectly by the decomposition of the compounds of formula (I), (II) or (III) according to the invention, for example thermally.

Naturally, further chromophores or coloured stabilisers may influence the optical properties of the recording layer. It is therefore preferable to use further chromophores or coloured stabilisers, the optical properties of which conform as far as possible to, or are as different as possible from, those of the compounds of formula (I), (II) or (III), or the amount of further chromophores is kept small.

When further chromophores having optical properties that conform as far as possible to those of compounds of formula (I), (II) or (III) are used, preferably this should apply in the range of the longest-wavelength absorption flank. Preferably the wavelengths of the inversion points of the further chromophores and of the compounds of formula (I), (II) or (III) are a maximum of 40 nm, especially a maximum of 20 nm, more especially a maximum of 10 nm, apart in that case the further chromophores and the compounds of formula (I), (II) or (III) should exhibit similar behaviour in respect of the laser radiation, so that it is possible to use as further chromophores known recording agents the action of which is synergistically enhanced or heightened by the compounds of formula (I), (II) or (III).

When further chromophores or coloured stabilisers having optical properties that are as different as possible from those of compounds of formula (I), (II) or (III) are used, they advantageously have an absorption maximum that is hypsochromically or bathochromically shifted relative to the dye of formula (I), (II) or (III). In that case the absorption maxima are preferably at least 50 nm, especially at least 100 nm, apart Examples thereof are UV absorbers that are hypsochromic to the dye of formula (I), (II) or (III), or coloured stabilisers that are bathochromic to the dye of formula (I), (II) or (III) and have absorption maxima lying, for example, in the NIR or IR range. Other dyes can also be added for the purpose of colour-coded identification, colour-masking (“diamond dyes”) or enhancing the aesthetic appearance of the recording layer. In all those cases, the behaviour of the further chromophores or coloured stabilisers towards light and laser radiation should preferably be as inert as possible.

When another dye is added in order to modify the optical properties of the compounds of formula (I), (II) or (III), the amount thereof is dependent upon the optical properties to be achieved. The person skilled in the art will find little difficulty in varying the ratio of additional dye to compound of formula (I), (II) or (III) until he obtains the desired result.

When chromophores or coloured stabilisers are used for other purposes, the amount thereof should preferably be small so that their contribution to the total absorption of the recording layer in the range of from 600 to 700 nm is a maximum of 20%, preferably a maximum of 10%. In such a case, the amount of additional dye or stabiliser is advantageously a maximum of 50% by weight, preferably a maximum of 10% by weight, based on the recording layer.

Further chromophores which can optionally be used in the recording layer in addition to the compounds of formula (I), (II) or (III) are, for example, cyanines and cyanine metal complexes (U.S. Pat. No. 5,958,650), styryl compounds (U.S. Pat. No. 6,103,331), oxonol dyes (EP-A-833 314), azo dyes and azo metal complexes (JP-A-11/028865), phthalocyanines (EP-A-232 427, EP-A-337 209, EP-A-373 643, EP-A-463 550, EP-A-492 508, EP-A-509 423, EP-A-511 590, EP-A-513 370, EP-A-514 799, EP-A-518 213, EP-A-519 419, EP-A-519 423, EP-A-575 816, EP-A-600 427, EP-A-676 751, EP-A-712 904, WO-98/14520, WO-00/09522, CH-693/01), porphyrins and azaporphyrins (EP-A-822 546, U.S. Pat. No. 5,998,093), dipyrromethene dyes and metal chelate compounds thereof (EP-A-822 544, EP-A-903 733), xanthene dyes and metal complex salts thereof (U.S. Pat. No. 5,851,621) or quadratic acid compounds (EP-A-568 877), or oxazines, dioxazines, diazastyryls, formazans, anthraquinones or phenothiazines; this list is on no account exhaustive and the person skilled in the art will interpret the list as including further known dyes.

Especially preferred additional chromophores are especially cyanines and xanthenes. Of the cyanines, preference is given to benzoindocarbocyanines, and of the xanthenes especially rhodamines.

It is very especially preferred, however, that no additional chromophore is added, unless it is a coloured stabiliser.

Stabilisers or fluorescence-quenchers are, for example, metal complexes of N- or S-containing enolates, phenolates, bisphenolates, thiolates or bisthiolates or of azo, azomethine or formazan dyes, such as ®Irgalan Bordeaux EL (Ciba Spezialitätenchemie AG), ®Cibafast N3 (Ciba Spezialitätenchemie AG) or similar compounds, hindered phenols and derivatives thereof (optionally also as anions X⁻), such as ®Cibafast AO (Ciba Spezialitätenchemie AG), 7,7′,8,8′-tetracyanoquinodimethane (TCNQ) and compounds thereof (optionally as an anion of a charge transfer complex), hydroxyphenyl-triazoles or -triazines or other UV absorbers, such as ®Cibafast W or ®Cibafast P (Ciba Spezialitätenchemie AG) or hindered amines (TEMPO or HALS, also as nitroxides or NOR-HALS, optionally also as anions X⁻).

Many such structures are known, some of them also in connection with optical recording media, for example from U.S. Pat. No. 5,219,707, JP-A-06/199045, JP-A-07/76169 or JP-A-07/262604. They may be, for example, salts of the metal complex anions disclosed above with any desired cations, for example the cations disclosed above.

Also suitable are neutral metal complexes, for example those metal complexes disclosed in EP 0 822 544, EP 0 844 243, EP 0 903 733, EP 0 996 123, EP 1 056 078, EP 1 130 584 or U.S. Pat. No. 6,162,520, for example 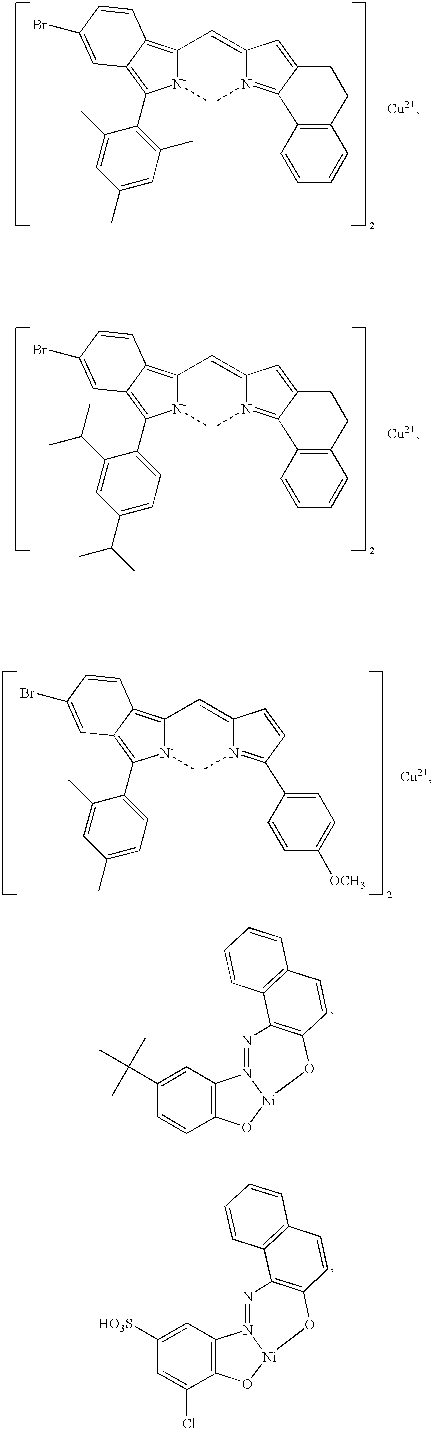 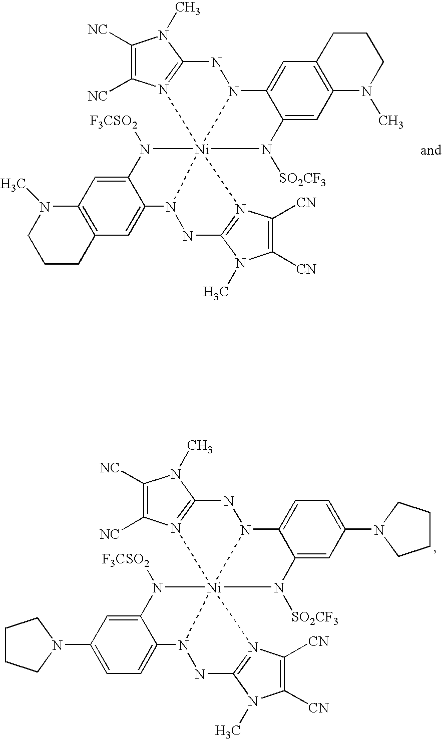
and other known metal complexes, illustrated, for example, by the compounds of formulae

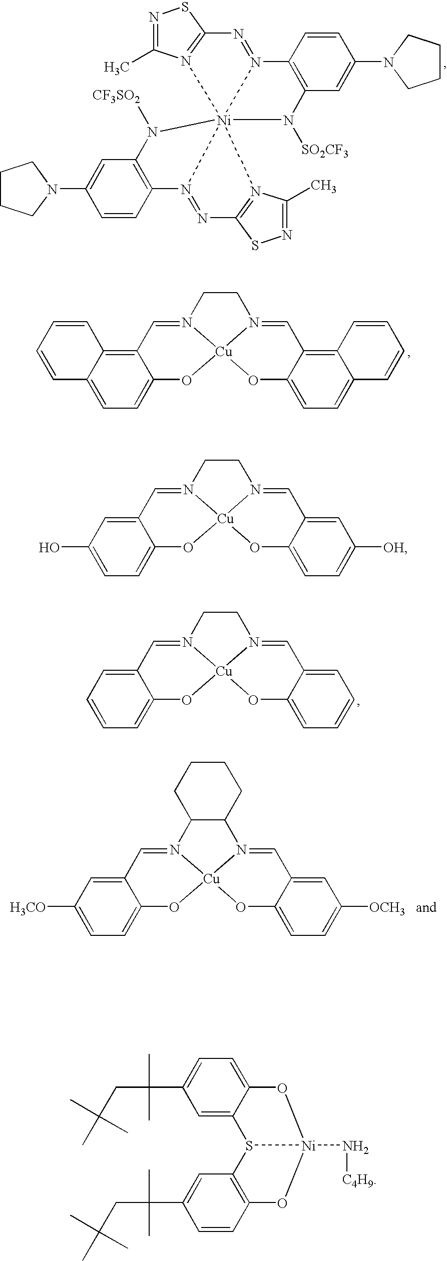

The person skilled in the art will know from other optical information media, or will easily identify, which additives in which concentration are particularly well suited to which purpose. Suitable concentrations of additives are, for example, from 0.001 to 1000% by weight, preferably from 1 to 50% by weight, based on the recording medium of formula (I), (II) or (III).

The recording medium according to the invention, in addition to comprising the compounds of formula (I), (II) or (III), may additionally comprise salts, for example ammonium chloride, pentadecylammonium chloride, cobalt(II) chloride, sodium chloride, sodium sulfate, sodium methylsulfonate or sodium methyl sulfate, the ions of which may originate, for example, from the components used. If present, the additional salts are preferably present in amounts of up to 20% by weight, based on the total weight of the recording layer.

Reflecting materials suitable for the reflective layer include especially metals, which provide good reflection of the laser radiation used for recording and playback, for example the metals of Main Groups III, IV and V and of the Sub-Groups of the Periodic Table of the Chemical Elements. Al, In, Sn, Pb, Sb, Bi, Cu, Ag, Au, Zn, Cd, Hg, Sc, Y, La, Ti, Zr, Hf, V, Nb, Ta, Cr, Mo, W, Fe, Co, Ni, Ru, Rh, Pd, Os, Ir, Pt, Ce, Pr, Nd, Pm, Sm, Eu, Gd, Tb, Dy, Ho, Er, Tm, Yb and Lu and alloys thereof are especially suitable. Special preference is given to a reflective layer of aluminium, silver, copper, gold or an alloy thereof, on account of its high reflectivity and ease of production.

Materials suitable for the protective layer include chiefly plastics, which are applied in a thin layer to the support or to the uppermost layer either directly or with the aid of adhesive layers. It is advantageous to select mechanically and thermally stable plastics having good surface properties, which may be modified further, for example written on. The plastics may be thermosetting plastics or thermoplastic plastics. Preference is given to radiation-cured (e.g using UV radiation) protective layers, which are particularly simple and economical to produce. A wide variety of radiation-curable materials is known. Examples of radiation-curable monomers and oligomers are acrylates and methacrylates of diols, triols and tetrols, polyimides of aromatic tetracarboxylic acids and aromatic diamines having C₁-C₄alkyl groups in at least two ortho-positions of the amino groups, and oligomers having dialkylmaleinimidyl groups, e.g. dimethylmaleinimidyl groups.

The recording media according to the invention may also have additional layers, for example interference layers. It is also possible to construct recording media having a plurality of (for example two, three, four or five) recording layers. The structure and the use of such materials are known to the person skilled in the art. Where present, interference layers are preferably arranged between the recording layer and the reflecting layer and/or between the recording layer and the substrate and consist of a dielectric material, for example as described in EP 353 393 of TiO₂, Si₃N₄, ZnS or silicone resins.

The recording media according to the invention can be produced by processes known per se, it being possible for various methods of coating to be employed depending upon the materials used and their function.

Suitable coating methods are, for example, immersion, pouring, brush-coating, blade-application and spin-coating, as well as vapour-deposition methods carried out under a high vacuum. When, for example, pouring methods are used, solutions in organic solvents are generally employed. When solvents are employed, care should be taken that the supports used are not sensitive to those solvents. Suitable coating methods and solvents are described, for example, in EP-A401 791.

The recording layer is applied preferably by the application of a dye solution by spin-coating, solvents that have proved satisfactory being especially alcohols, e.g. 2-methoxyethanol, n-propanol, isopropanol, isobutanol, n-butanol, 1-methoxy-2-propanol, amyl alcohol or 3-methyl-1-butanol, or preferably fluorinated alcohols, for example 2,2,2-trifluoroethanol or 2,2,3,3-tetrafluoro-1-propanol, and mixtures thereof. It will be understood that other solvents or solvent mixtures can also be used, for example those solvent mixtures described in EP-A-511 598 and EP-A-833 316. Ethers (dibutyl ether), ketones (2,6-dimethyl heptanone, 5-methyl-2-hexanone), esters (e.g. the lactic acid esters known from WO-03/098617) or saturated or unsaturated hydrocarbons (toluene, xylene or as disclosed in WO-03/034 146 tert-butyl-benzene and similar compounds) can also be used, optionally also in the form of mixtures (e.g. dibutyl ether/2,6-dimethyl-4-heptan-one) or mixed components.

The person skilled in the art of spin-coating will in general routinely try all the solvents with which he is familiar, as well as binary and ternary mixtures thereof, in order to discover the solvents or solvent mixtures which result in a high-quality and, at the same time, cost-effective recording layer containing the solid components of his choice. Known methods of process engineering can also be employed in such optimisation procedures, so that the number of experiments to be carried out can be kept to a minimum.

The invention therefore relates also to a method of producing an optical recording medium, wherein a solution of a compound of formula (I), (II) or (III) in an organic solvent is applied to a substrate having depressions. The application is preferably carried out by spin-coating.

The application of the metallic reflective layer is preferably effected by sputtering, vapour-deposition in vacuo or by chemical vapour deposition (CVD). The sputtering technique is especially preferred for the application of the metallic reflective layer on account of the high degree of adhesion to the support Such techniques are known and are described in specialist literature (e.g. J. L. Vossen and W. Kern, “Thin Film Processes”, Academic Press, 1978).

The structure of the recording medium according to the invention is governed primarily by the readout method; known function principles include the measurement of the change in transmission or, preferably, reflection, but it is also known, for example, to measure the fluorescence instead of the transmission or reflection.

When the recording material is structured for a change in reflection, the following structures, for example, can be used: transparent support/recording layer (optionally multilayered)/reflective layer and, if expedient, protective layer (not necessarily transparent); or support (not necessarily transparent)/reflective layer/recording layer and, if expedient, transparent protective layer. In the first case, the light is incident from the support side, whereas in the latter case the radiation is incident from the recording layer side or, where applicable, from the protective layer side. In both cases the light detector is located on the same side as the light source. The first-mentioned structure of the recording material to be used according to the invention is generally preferred.

When the recording material is structured for a change in light transmission, the following different structure, for example, comes into consideration: transparent support/recording layer (optionally multilayered) and, if expedient, transparent protective layer. The light for recording and for readout can be incident either from the support side or the recording layer side or, where applicable, the protective layer side, the light detector in this case always being located on the opposite side.

Suitable lasers are those having a wavelength of from 600 to 700 nm, for example commercially available lasers having a wavelength of 602, 612, 633, 635, 647, 650, 670 or 680 nm, especially semi-conductor lasers, such as GaAsAl, InGaAlP or GaAs laser diodes having a wavelength especially of about 635, 650 or 658 nm. The recording is effected, for example, point for point in a manner known per se, by modulating the laser in accordance with the mark lengths and focussing its radiation onto the recording layer. It is known from the specialist literature that other methods are currently being developed which may also be suitable for use.

The method according to the invention allows the storage of information with great reliability and stability, distinguished by very good mechanical and thermal stability and by high light stability and by sharp pit boundary zones. Special advantages include the high contrast, the low jitter and the surprisingly high signal/noise ratio, so that excellent readout is achieved. The high storage capacity is especially valuable in the field of video and multimedia.

The readout of information is carried out according to methods known per se by registering the change in absorption or reflection using laser radiation, for example as described in “CD-Player und R-DAT Recorder” (Claus Biaesch-Wiepke, Vogel Buchverlag, Würzburg 1992).

The information-containing medium according to the invention is especially an optical information material of the WORM type. It can be used, for example, as a playable DVD, (digital versatile disk), as material for a computer or as an identification and security card or for the production of diffractive optical elements, for example holograms.

The invention accordingly relates also to a method for the optical recording, storage and playback of information, wherein a recording medium according to the invention is used. The recording and/or the playback advantageously take place in a wavelength range of from 600 to 700 nm, preferably as already indicated.

The invention relates also to the compounds used according to the invention insofar as they are novel. The invention relates accordingly also to a compound of formula (II) or (III) or a tautomeric or mesomeric form thereof, wherein R₂ is O⁻, S⁻, N⁻COR₁₁, N⁻COOR₉, N⁻CONR₁₂R₁₃ or N⁻CN.

The following Examples illustrate the invention in greater detail (all percentages are by weight, unless otherwise indicated):

### EXAMPLE 1

49.8 g of 2-amino-5-nitrophenol are added to a solution of 75.0 ml of 37% hydrochloric acid in 750 ml of ethanol. After cooling to 0-5° C., 79.5 ml of an aqueous 4 M sodium nitrite solution are introduced over a period of 30 min. The yellow suspension is stirred for 1 hour at 0-5° C., then within a period of 30 min. added dropwise to a cold solution of 33 g of resorcinol in 600 ml of water at pH 9.5-10. The pH is adjusted to that value by simultaneous dropwise addition of 165 ml of 5 M sodium hydroxide solution. A dark violet suspension is obtained which, after being stirred for one hour to complete the reaction, is neutralised with 4 M hydrochloric acid and filtered. The residue is washed with water and dried at 50-55° C./2-5·10³ Pa for 48 hours. 79.7 g of brown powder of the following formula are obtained:

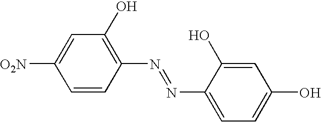

### EXAMPLE 2

Analogously to Example 1, 21.3 g of brown powder of the following formula are obtained:

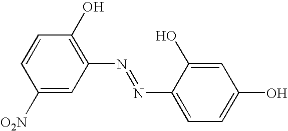

### EXAMPLE 3

18.2 g of product according to Example 1 are dissolved in 300 ml of ethanol at 70° C. 7.5 g of cobalt(II) acetate tetrahydrate are added to the red solution, the colour changing from red to violet. After 2 hours at 70° C., the mixture is cooled to 50° C. and clarified by filtration. 1500 ml of hexane are added slowly to the filtrate at 23° C. and the precipitate is filtered off. The residue is washed with propanol and dried at 85° C./1 Pa for 12 hours, yielding 12.6 g of black powder of the following structure:

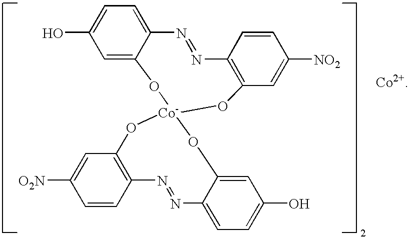

This product, which contains traces of solvents, can be purified by chromatography (silica gel 32-63, CB 09332-22/Brunschwig Chemie, eluant: ethyl acetate/isopropanol/acetic acid/water 12:3:1:1 vol/vol).

¹H-NMR: 8.48/8.51(d), 7.80/7.83(d), 7.61/7.64(d), 7.40(s), 6.39/6.42(d), 6.05(s); R_{f}: 0.78 violet (silica gel, butyl acetate/pyridine/water 8:8:3 vol/vol); cobalt 12.1% (th. 12.57%); UV/VIS (ethanol): λₘₐₓ=545 nm/ε=29100; on addition of NaOH: λₘₐₓ=573 nm /=49400.

### EXAMPLE 4

The procedure is analogous to Example 3, but 4.1 g of the product according to Example 2 are used instead of the product according to Example 1, yielding 1.3 g of black powder of the following structure:

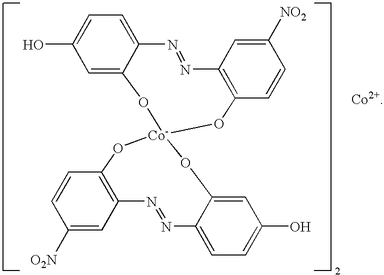

This product, which contains traces of solvents, can be purified by chromatography (silica gel 32-63, CB 09332-22/Brunschwig Chemie, eluant ethyl acetate/isopropanol/acetic acid/water 12:3:1:1 vol/vol).

¹H-NMR: 9.10(s). 7.95;7.98(d). 7.79/7.82(d). 6.68:6.71(d). 6.31;6.34(d), 6.00(s); R_{f}: 0.78 orange (silica gel, butyl acetate/pyridine/water 8:8:3 vol/vol); cobalt: 12.3% (th. 12.57%); UV/VIS (ethanol): λₘₐₓ=479 nm/ε=29600; on addition of NaOH: λₘₐₓ=525 nm/ε=44000.

### EXAMPLE 5

The procedure is analogous to Example 3, but 12.1 g of the product according to Example 1 and nickel(II) acetate tetrahydrate are used instead of cobalt acetate tetrahydrate, yielding 6.6 g of dark-brown powder of formula:

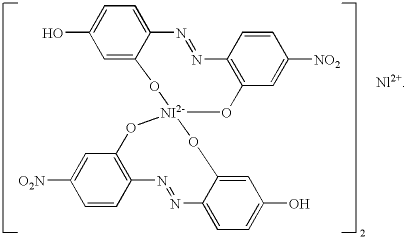

UV/VIS (ethanol): λₘₐₓ=533 nm/ε=43500; on addition of NaOH: λₘₐₓ=580 nm /ε=54200.

### COMPARISON EXAMPLE 1

Compound No. 2 according to U.S. Pat. No. 6,168,843 is prepared:

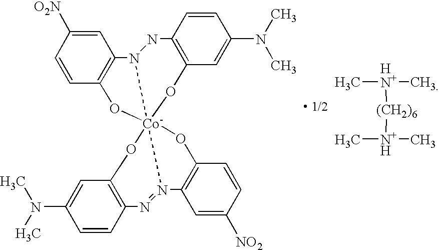

### EXAMPLES 6-7+COMPARISON EXAMPLE 2

1.0% by weight of each of the compounds according to Examples 3 and 4 and the Comparison Example is dissolved in 1-propanol and applied to a planar polycarbonate substrate by spin-coating. The optical parameters of the solid layer are determined by means of an ETA spectral reflection/transmission tester (Steag ETA-Optik GmbH):

| Compound according to: | kₘₐₓ | nₘₐₓ |
|---|---|---|
| Example 3 | 0.77 | 2.37 |
| Example 4 | 0.80 | 2.45 |
| Comparison Example 1 | 0.82 | 2.30 |

Using the compounds according to the invention, the refractive index ascertained in the solid is surprisingly significantly higher than in the case of the comparison compound.

### EXAMPLE 8

A solution of 0.45 g of the compound according to Example 3 and 1.35 g of the compound according to Example 4 in 19.6 g of 2-ethoxy-ethanol and 59.0 g of n-propanol is filtered through a Teflon filter having a pore size of 0.2 μm and applied by spin-coating at 1500 rev/min to the surface of a 0.6 mm thick, grooved polycarbonate disc (groove depth: 190 nm, groove width: 290 nm, track pitch 0.74 μm) having a diameter of 120 mm. The excess of solution is spun off by increasing the speed of rotation. When the solvent is evaporated off, the dye remains behind in the form of a uniform, amorphous solid layer. Drying is carried out in a circulating-air oven at 70° C. (10 min). In a vacuum-coating apparatus (Twister, Balzers Unaxis), a 60 nm thick silver layer is then applied to the recording layer by atomisation. A 6 μm thick protective layer of a UV-curable photopolymer (™650-020, DSM) is then applied thereto by spin-coating. The recording support has good reflectivity at 658 nm. On a commercial recording apparatus (Pioneer A03 DVD-R(G)), using a laser diode of wavelength 658 nm with a laser output of 9.8 mW marks are written at a speed of 3.5 m·s⁻¹.

### EXAMPLES 9-10

The procedure is analogous to Example 8, but the compounds according to Example 4 or 5 are used instead of the product according to Example 3.

### EXAMPLE 11

4.13 g of the product according to Example 2 are stirred in 200 ml of water and dissolved with 27.0 ml of 20% soda solution followed by 1.8 ml of 15% sodium hydroxide solution at 50° C. Then, at 50-60° C., within a period of 1 hour titration is carried out with 7.0 ml of 1 M cobalt acetate solution (change from yellow/orange to red), the pH value being kept constant at 8.5-9 with 0.4 ml of 15% sodium hydroxide solution. Then 40 g of NaCl are added and, after cooling to 23° C., the pH value is adjusted to 8.5 with 6.0 ml of 2N HCl and stirring is then carried out for 2 hours. The precipitated product is filtered off, washed with 500 ml of 10% NaCl solution and dried for 12 hours at 70° C./1 Pa. 8.3 g of crude product of formula 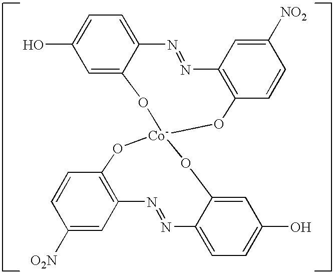
Na⁺ are obtained, which, if desired, can be recrystallised from n-propanol.

### EXAMPLE 12

Analogously to the previous Examples, the compound of formula 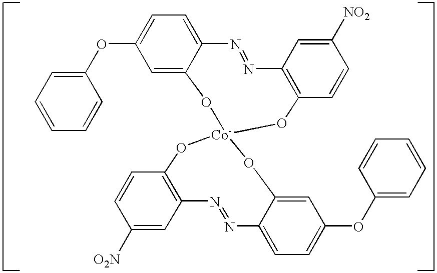
Na⁺ is obtained.

### EXAMPLE 13

Analogously to the previous Examples, the compound of formula 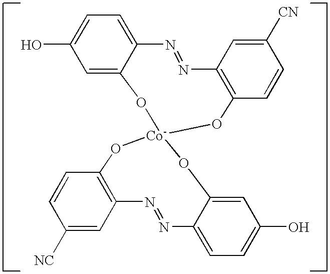
Na⁺ is obtained.

### EXAMPLE 14

A solution of 2 g of the compound of formula 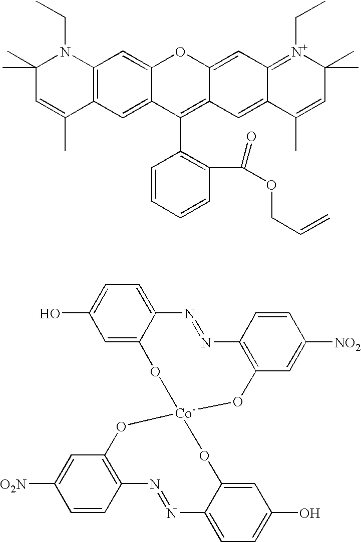
in 94 g of 1-methoxy-2-propanol and 3 g of cyclopentanol is filtered through a Teflon filter having a pore size of 0.2 μm and applied by spin-coating at 1800 rev/min to the surface of a 0.6 mm thick, grooved polycarbonate disc (groove depth: 170 nm, groove width: 330 nm, track pitch 0.74 μm) having a diameter of 120 mm. The excess of solution is spun if by increasing the speed of rotation. When the solvent is evaporated off, the dye remains behind in the form of a uniform, amorphous solid layer. Drying is carried out in a circulating-air oven at 70° C. (20 min). The optical values are good (n₆₅₈=2.47/k₆₅₈=0.056). In a vacuum-coating apparatus (Twister, Balzers Unaxis), a 80 nm thick silver layer is then applied to the recording layer by atomisation. A protective layer of a UV-curable photopolymer (™650-020, DSM) is then applied thereto by spin-coating. The recording support has a reflectivity of 46% at 658 nm. On a commercial test apparatus (DDU-1000, Pulstec Japan), using a laser diode of wavelength 658 nm marks are written into the active layer at a speed of 3.5 m·s⁻¹ and at an output of 8.7 mW. Then, on a commercial test apparatus (DVD Pro, Audio Dev), the following dynamic parameters are determined: DTC jitter 7.5%, R14H 46%, I14/I14H 0.57; asymmetry 7.8%. The medium exhibits especially a high sensitivity.

### EXAMPLE 15

The procedure is analogous to Example 14, but the compound of formula 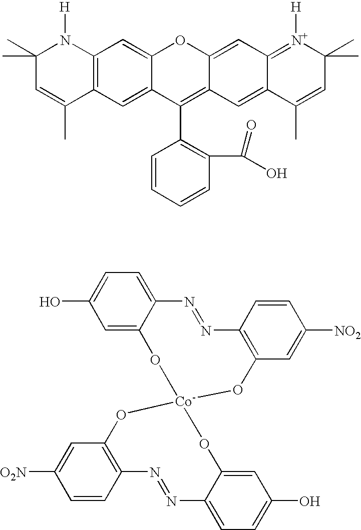
is used and yields comparably good results.

### EXAMPLES 16-17

The procedure is analogous to Examples 14 and 15, but instead of the anions according to Examples 3 and 4 there are used the anions according to Examples 12 and 13.

### EXAMPLE 18

A solution of 2.0 g of the compound of formula 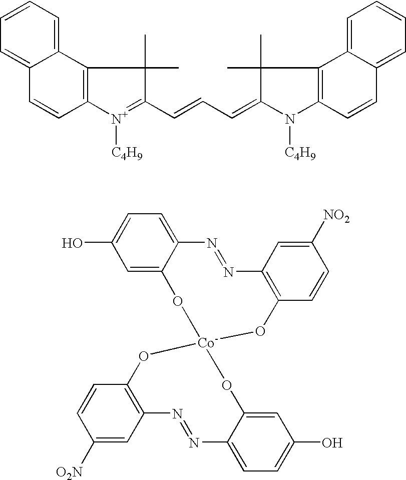
in 93.0 g of 1-methoxy-2-propanol and 5.0 g of 2-ethoxyethanol is filtered through a Teflon filter having a pore size of 0.2 μm and applied by spin-coating at 1500 rev/min to the surface of a 0.6 mm thick, grooved polycarbonate disc (groove depth: 170 nm, groove width: 330 nm, track pitch 0.74 μm) having a diameter of 120 mm. The excess of solution is spun off by increasing the speed of rotation. When the solvent is evaporated off, the dye remains behind in the form of a uniform, amorphous solid layer. Drying is carried out in a circulating-air oven at 70° C. (20 min). In a vacuum-coating apparatus (Twister, Balzers Unaxis), a 80 nm thick silver layer is then applied to the recording layer by atomisation. A protective layer of a UV-curable photopolymer (™650-020, DSM) is then applied thereto by spin-coating. The recording support has good reflectivity at 658 nm. On a commercial recording apparatus (Pioneer A03 DVD-R(G)), using a laser diode of wavelength 658 nm at a laser output of 11.2 mW marks are written into the active layer at a speed of 3.5 m·s⁻¹. Then, on a commercial test apparatus (DVD Pro, Audio Dev), the following dynamic parameters are determined: DTC jitter, R14H, I14/I14H.

### EXAMPLES 19-24

The procedure is analogous to Examples 8, 14, 15, 16, 17 and 18, but a writing speed of 7.0 m·s⁻¹ (2×) is used instead of 3.5 m·s⁻¹ (1×). The results are satisfactory to good.

### EXAMPLES 25-29

The procedure is analogous to Examples 14, 15, 16, 17 and 18, but a writing speed of 14.0 m·s⁻¹ (4×) is used instead of 3.5 m·s⁻¹ (1×). The results are excellent, especially in the case of media conforming to DVD-R specifications.

### EXAMPLE 30

The procedure is analogous to the previous Examples, but the compound of formula

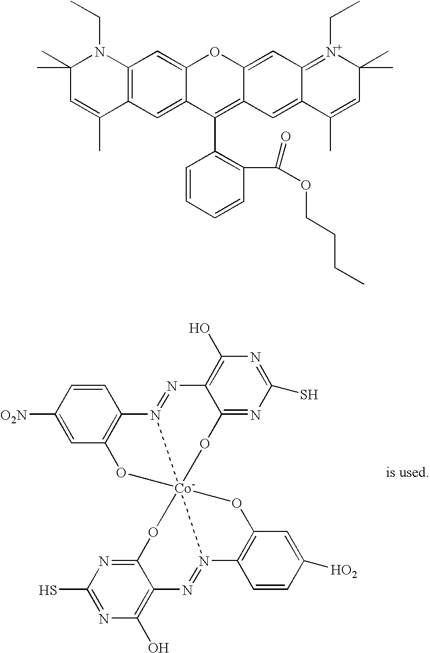

Very good test results are obtained at writing speeds of 3.5 m·s⁻¹ (1×) to 14.0 m·s⁻¹ (4×). The optical parameters of the solid layer are determined by means of an ETA spectral reflection/transmission tester (Steag ETA-Optik GmbH):

| Compound according to: | k₆₅₈ | n₆₅₈ |
|---|---|---|
| Example 30 | 0.04 | 2.30 |

On a commercial test apparatus (DDU-1000, Pulstec Japan), using a laser diode of wavelength 658 nm marks are written into the active layer at speeds of 3.5 m·s⁻¹ (1×) and 14 m·s⁻¹ (4×). Then, on a commercial test apparatus (DVD Pro, Audio Dev), the following dynamic parameters are determined: data-to-dock jitter, R14H, I14/I14H, asymmetry.

| Writing speed | R14H | | DC Jitter | Asymmetry | Output |
|---|---|---|---|---|---|
| [m · s⁻¹] | [%] | I14/I14H | [%] | [%] | [mW] |
| 3.5 (1×) | 46 | 0.60 | 6.8 | 13 | 10 |
| 14 (4×) | 46 | 0.68 | 6.9 | −2 | 17 |

### EXAMPLE 31

60.0 g of 97% 2-amino-5-nitrothiazole are dissolved, with stirring, in 880 ml of 50% (vol.) sulfuric acid at 23° C. The light-brown solution is cooled to −10° C. In the course of 40 minutes, 100 ml of aqueous 4 N sodium nitrite solution are added. The now dark blue-green solution is stirred at from −10 to −8° C. for a further 15 minutes. During that time 48 g of resorcinol are dissolved in 400 ml of ethanol and cooled to −10 to −15° C. The resulting solution is then added slowly to the diazonium solution. Immediately a thick, dark-red precipitate is formed and the temperature rises to about 0° C. The reaction mixture is then stirred for a further 2 hours at from 0 to 5° C., diluted with 500 ml of water and filtered with suction. The suction-filtered material is washed with 4 litres of water and dried for 24 hours at 60° C./10³ Pa, yielding 78 g of red-brown product of formula:

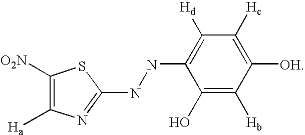

¹H-NMR [ppm]: 8.87 (s, Hₐ); 6.46 (s, H_{b}); 6.49/6.52 (d, H_{c}); 7.71/7.74 (d, H_{d}).

### EXAMPLE 32

25 g of the compound according to Example 31 are introduced into 100 ml of dimethylacetamide and stirred at 23° C. Then 12.7 g of cobalt(II) acetate tetrahydrate are added. Both starting materials slowly dissolve and an almost black solution is formed which is stirred at room temperature for 3 hours. After that time a dark-red precipitate has formed, which is filtered with suction through a Büchner filter and washed with 20 ml of dimethylacetamide. The suction-filtered material is suspended, with stirring, in 1.2 litres of methanol. After the addition of 10 g of sodium acetate (anhydrous) the reaction mixture is heated to 60-65° C. and clarified by filtration at that temperature. The filtrate is concentrated to 200 ml using a rotary evaporator and cooled to from 5 to 10° C., whereupon crystallisation begins. The precipitate is filtered with suction and washed with 50 ml of methanol of a temperature of 0-5° C. Drying at 50-55° C./10³ Pa yields 15 g of an almost black product of formula:

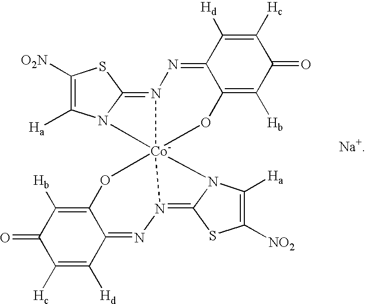

¹H-NMR [ppm]: 7.99 (s, Hₐ), 5.32 (s, H_{b}) 6.22/6.25 (d, H_{c}); 7.81/7.85 (d, H_{d}).

### EXAMPLE 33

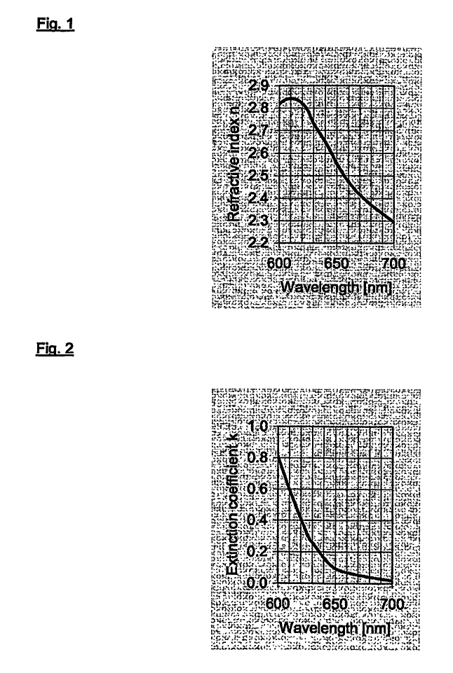

1.5 g of the compound according to Example 32 are dissolved in 98.5 g of 1-methoxy-2-propanol and filtered through a 02 μm Teflon filter. The dye solution is then applied at 250 rev/min to a 1.2 mm thick, planar polycarbonate disc (diameter 120 mm) and the speed of rotation is increased to 1200 rev/min so that the excess of solution is spun off and a uniform solid layer is formed. After drying, the solid layer has an optical density of 0.64 at 547 nm. Using an optical measuring system (ETA-RT, STEAG ETA-Optik), the layer thickness and the complex refractive index are determined. At 658 nm the dye layer has a thickness of 47.7 nm, a refractive index n of 2.49 and an extinction coefficient k of 0.072. FIG. 1 shows the refractive index n as a function of wavelength. FIG. 2 shows the extinction coefficient k as a function of wavelength.

### EXAMPLE 35

The procedure is analogous to Example 34, but a colorant of the following formula is used:

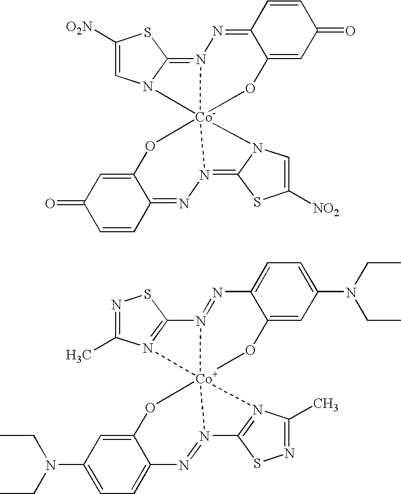

### EXAMPLE 36

The procedure is analogous to Example 34, but a colorant of the following formula is used:

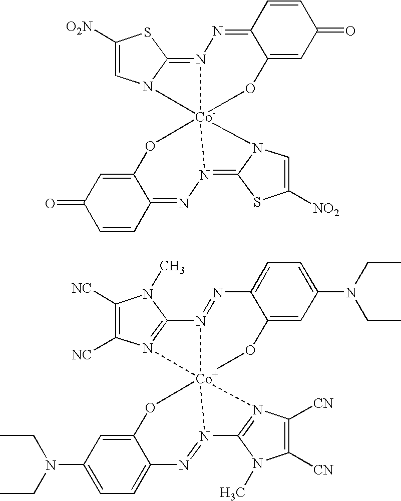

### EXAMPLES 37-42

The procedure is analogous to Example 34, but the following mixtures of compounds in accordance with Examples 34, 35 and 36 are used:

| | Example: | | | | | |
|---|---|---|---|---|---|---|
| | 37 | 38 | 39 | 40 | 41 | 42 |
| Example 34 | 50% | — | 50% | 80% | 80% | 40% |
| Example 35 | 50% | 50% | — | 20% | — | 30% |
| Example 36 | — | 50% | 50% | — | 20% | 30% |

### EXAMPLE 43

2.2 g of the compound according to Example 32 are dissolved in 100 ml of 1-methoxy-2-propanol and filtered through a Teflon filter having a pore size of 0.2 μm. The dye solution is then applied at 250 rev/min to the surface of a 0.6 mm thick, grooved polycarbonate disc (groove depth 164 nm, groove width 380 nm, track pitch 0.74 mm) having a diameter of 120 mm. The excess of solution is spun off by increasing the speed of rotation. When the solvent is evaporated off, the dye remains behind in the form of a uniform, amorphous solid layer. Drying is carried out in a circulating-air oven at 70° C. (20 min). The solid layer has an optical density of 0.57 at a wavelength of 534 nm. In a vacuum-coating apparatus (Twister, Balzers Unaxis) a 120 nm thick silver layer is then applied to the recording layer by atomisation. An adhesive layer of a UV-curable photopolymer (LMD2277™, Vantico/Huntsman) is then applied thereto by spin-coating, and a second polycarbonate disc is adhesively bonded thereto. The recording support has a reflectivity of 46% at 658 nm. On a commercial test apparatus (DDU-1000, Pulstec Japan), using a laser diode of wavelength 658 nm marks are written into the active layer at speeds of 3.5 m·s⁻¹ (1×) and 14 m·s⁻¹ (4×). Then, on a commercial test apparatus (DVD Pro, Audio Dev), the following dynamic parameters are determined: data-to-clock jitter, R14H, I14/I14H, asymmetry. After routine optimisation of the writing strategy, especially low values for DC jitter are obtained.

| Writing speed | R14H | | DC Jitter | Asymmetry |
|---|---|---|---|---|
| [m · s⁻¹] | [%] | I14/I14H | [%] | [%] |
| 3.5 (1×) | 46 | 0.62 | 6.6 | 12 |
| 14 (4×) | 46 | 0.69 | 7.0 | 4 |

### EXAMPLE 44

Analogously to Examples 6 to 10, an approximately 50 to 100 nm thick recording layer is applied by spin-coating to a planar glass disc substrate and dried. An approximately 100 to 150 nm thick silver reflector layer is then applied thereto by sputtering. The disc is placed, reflector layer downwards, onto a regulated heating table having a polished chromium steel surface and a surface temperature of 30° C. Using a fibre spectrophotometer, the reflection spectrum of the disc relative to a reference disc containing only the silver layer is measured from above through the glass substrate. The temperature of the heating table is then increased continuously to 300° C. at a rate of 5° C./minute and the reflection spectrum is measured at 1 minute intervals. Above a threshold temperature T₀ that is characteristic of the recording layer in question there is observed a continuous increase in reflection in the region of the reflection minimum at λ≈600 nm, i.e. a decrease in the absorption of the corresponding absorption band. At the characteristic temperature T_{1/2} the absorption band is reduced by 50%, in the case of T₁ by 100%, the absorption spectra measured between T₀ and T₁ generally being in good agreement with a linear combination of the absorption spectra at T₀ and T₁. Experience has shown that the optimum temperature range for the recording and playback properties of the disc is T₀>200° C., T_{1/2}≈250° C., T₁<300° C. The following data are measured:

| | T₀ | T_{½} | T₁ |
|---|---|---|---|
| Compound according to Example 30 | 220° C. | 260° C. | 300° C. |
| Compound according to Example 32 | 210° C. | 250° C. | 290° C. |
| Comparison compound of formula: | | | |
| 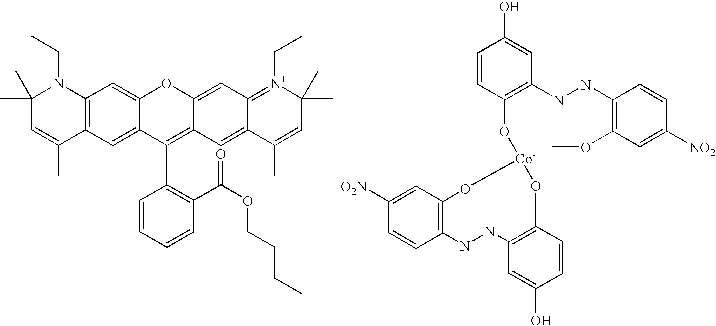 | 230° C. | 280° C. | >300° C. |

### EXAMPLES 45-91

Analogously to Examples 6 to 10, the n- and k-values (using a Steag ETA-Optik) and the photostability (relative decrease in absorption −D₉₀ after 90 hours' and −D₂₄ after 24 hours' irradiation with a calibrated xenon lamp/Hanau) of recording layers are determined, the following compounds being used:

| Ex- | | | | | |
|---|---|---|---|---|---|
| am- | | λₘₐₓ | | | −D₉₀ |
| ple | Structure | [nm] | n₆₅₈ | k₆₅₈ | [%] |
| 45 | 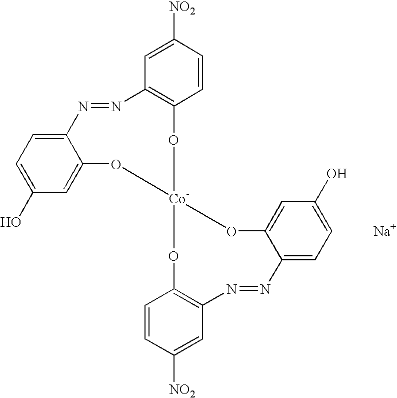 | 544 | 2.1 | 0.013 | 13 |
| 46 | 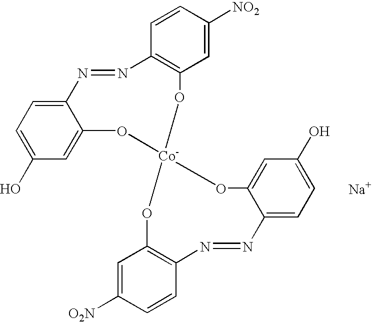 | 575 | 2.36 | 0.244 | 13 |
| 47 | 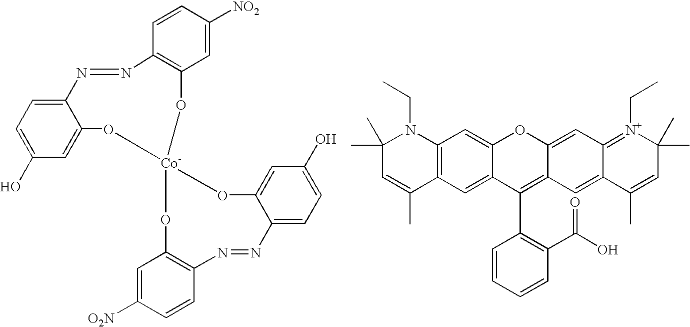 | 612 | 2.31 | 0.093 | 29 |
| 48 | 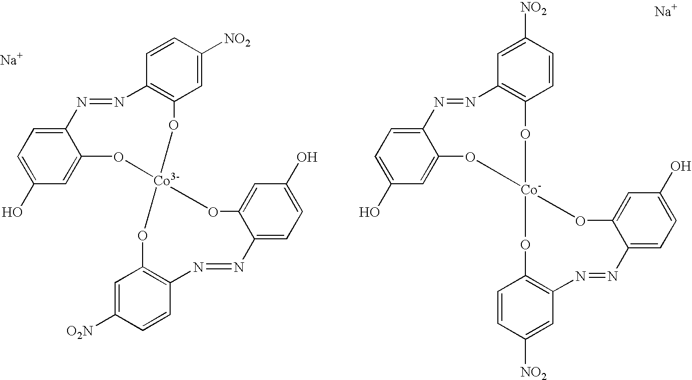 | 541 | 2.14 | 0.109 | 14 |
| 49 | 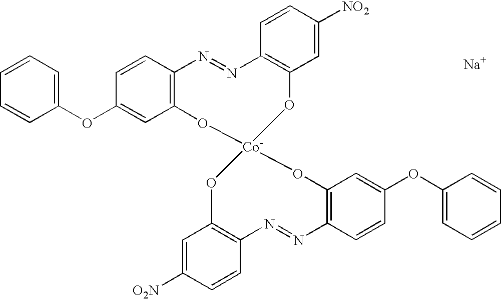 | 581 | 1.96 | 0.087 | 4 |
| 50 | 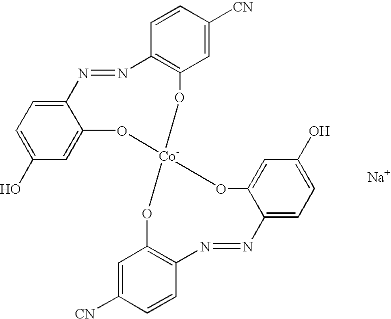 | 544 | 1.98 | 0.034 | 3 |
| 51 | 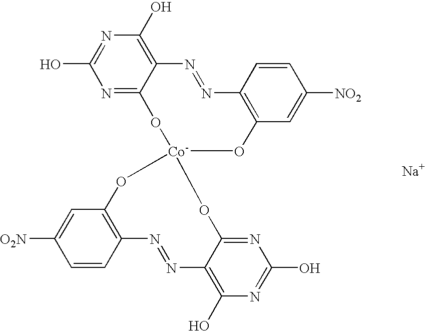 | 513 | 1.95 | 0.009 | 0 |
| 52 | 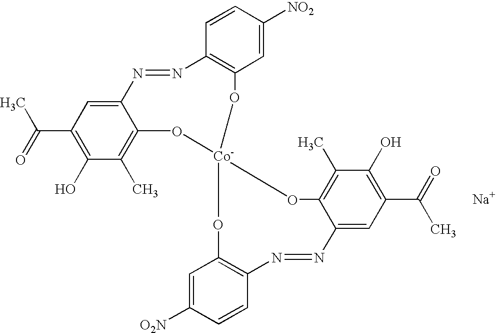 | 533 | 2.11 | 0.059 | 7 |
| 53 | 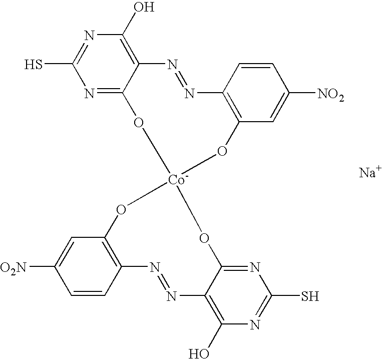 | 549 | 2.01 | 0.022 | 8 |
| 54 | 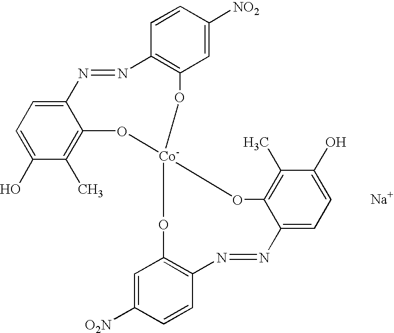 | 604 | 2.17 | 0.258 | 21 |
| 55 | 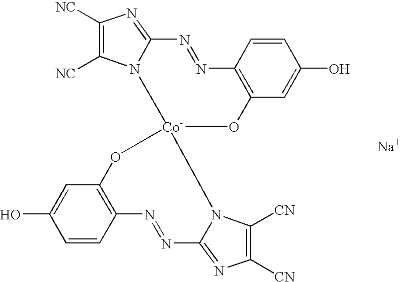 | 594 | 2.14 | 0.098 | 8 |
| 56 | 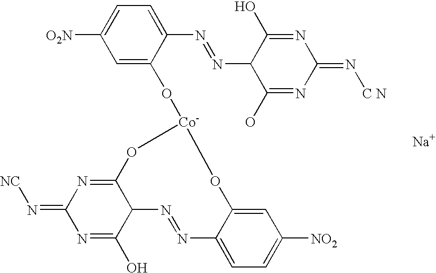 | 544 | 1.95 | 0.018 | 3 |
| 57 | 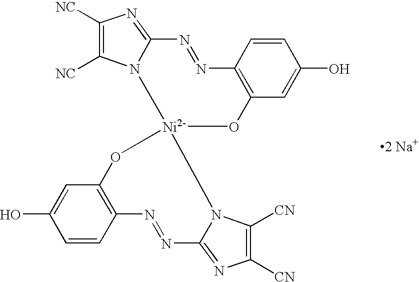 | 523 | 1.94 | 0.009 | 47 |
| 58 | 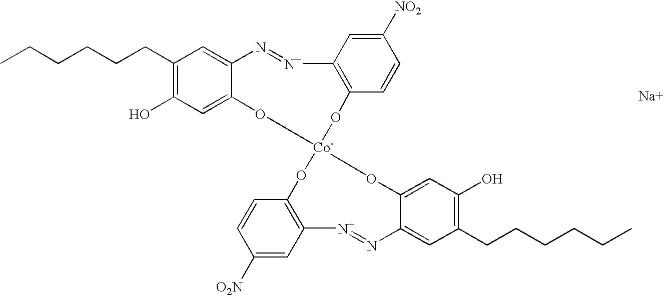 | 547 | 1.95 | 0.026 | 12 |
| 59 | 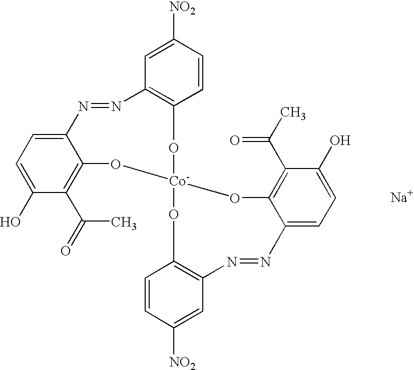 | 535 | 2.02 | 0.042 | 2 |
| 60 | 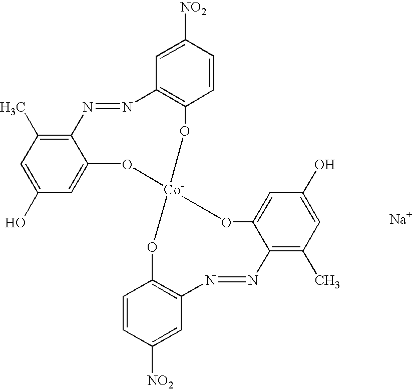 | 550 | 2.04 | 0.02 | 22 |
| 61 | 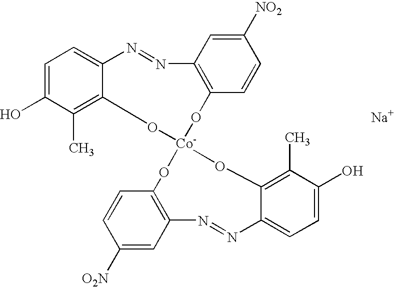 | 423 | 1.99 | 0.021 | 16 |
| 62 | 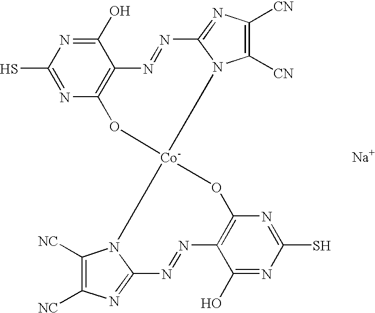 | 442 | 1.87 | 0.01 | 11 |
| 63 | 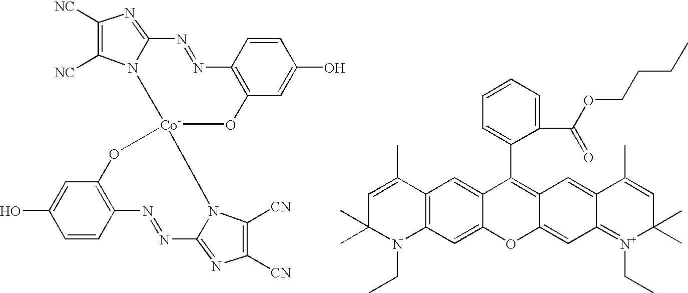 | 615 | 2.25 | 0.043 | 3 |
| 64 | 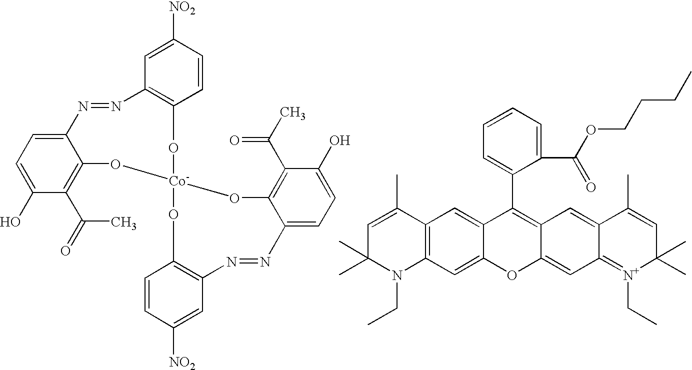 | 613 | 2.19 | 0.032 | — |
| 65 | 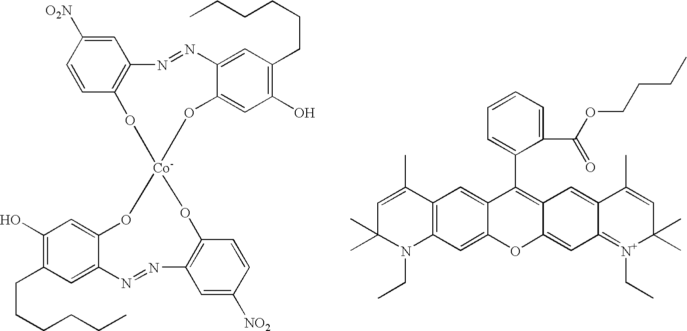 | 615 | 2.12 | 0.045 | — |
| 66 | 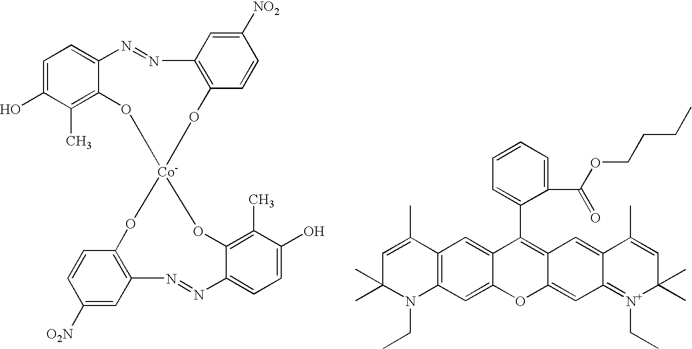 | 615 | 2.25 | 0.041 | 36 |
| 67 | 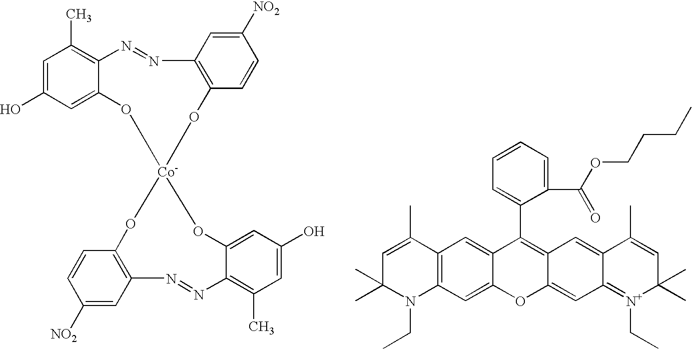 | 615 | 2.19 | 0.046 | 28 |
| 68 | 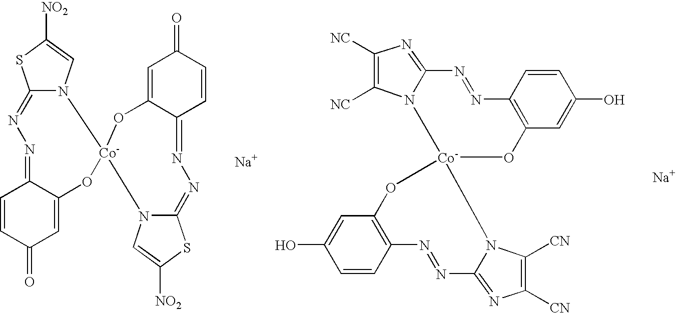 | 555 | 2.31 | 0.109 | 16 |
| 69 | 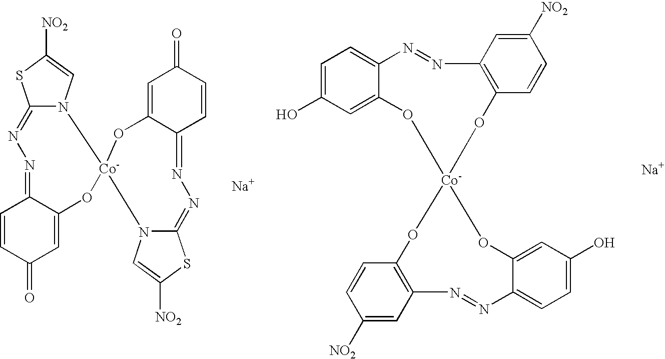 | 536 | 2.36 | 0.067 | 21 |
| 70 | 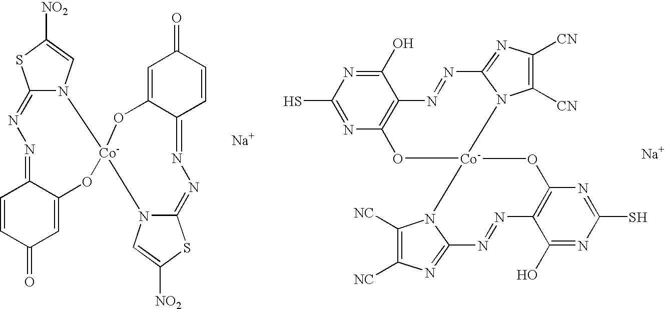 | 539 | 2.34 | 0.066 | 23 |
| 71 | 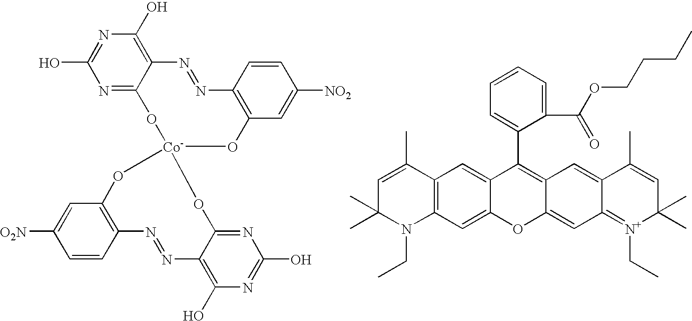 | 615 | 2.25 | 0.039 | 19 |
| 72 | 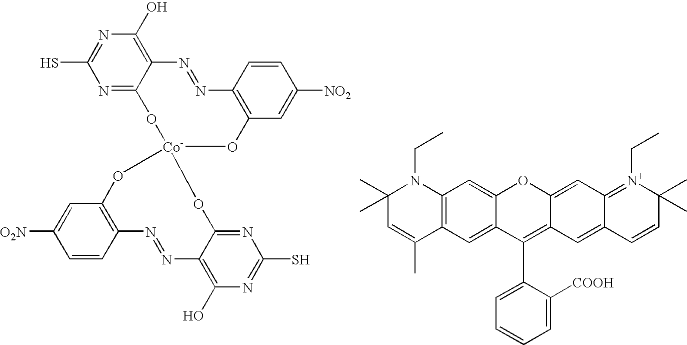 | 616 | 2.29 | 0.052 | 10 |
| 73 | 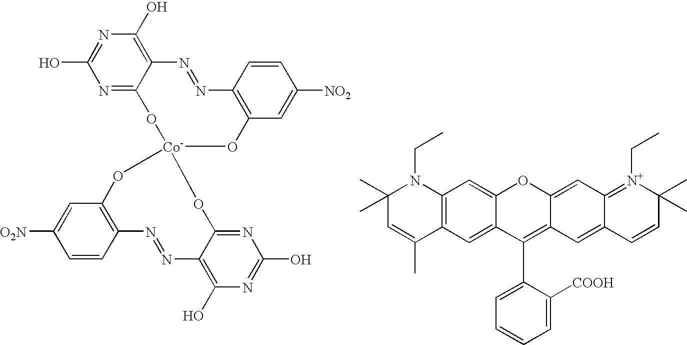 | 614 | 2.24 | 0.04 | 27 |
| 74 | 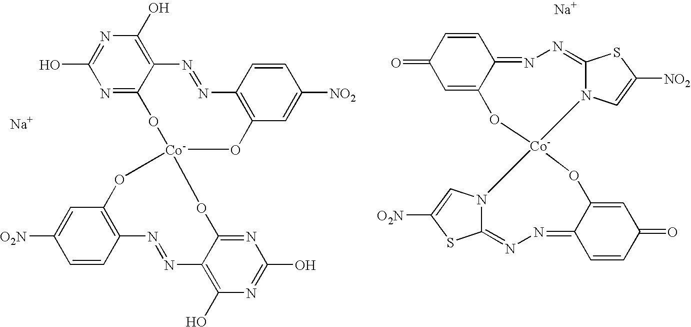 | 537 | 2.2 | 0.06 | 12 |
| Ex- | | | | | |
| am- | | λₘₐₓ | | | −D₂₄ |
| ple | Structure | [nm] | n₆₅₈ | k₆₅₈ | [%] |
| 75 | 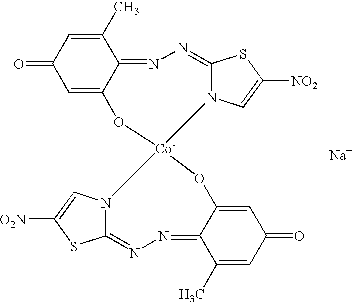 | 561 | 2.39 | 0.065 | 6 |
| 76 | 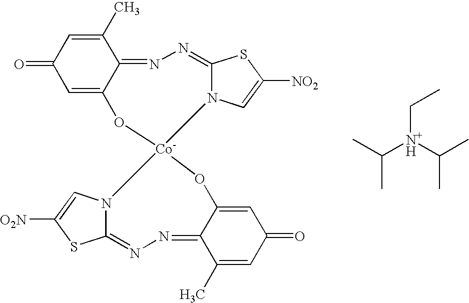 | 543 | 2.22 | 0.046 | 9 |
| 77 | 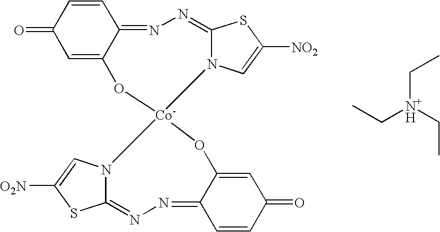 | 538 | 2.31 | 0.063 | 13 |
| 78 | 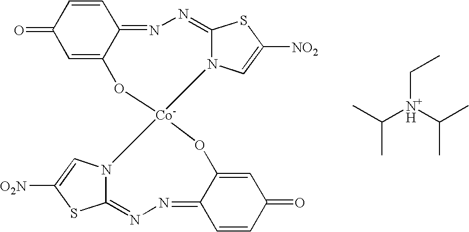 | 534 | 2.24 | 0.042 | 11 |
| 79 | 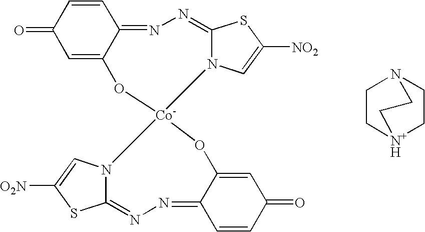 | 554 | 2.3 | 0.054 | 17 |
| 80 | 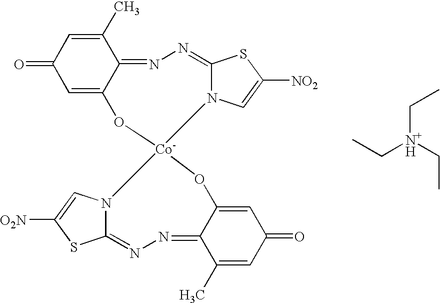 | 545 | 2.28 | 0.062 | 20 |
| 81 | 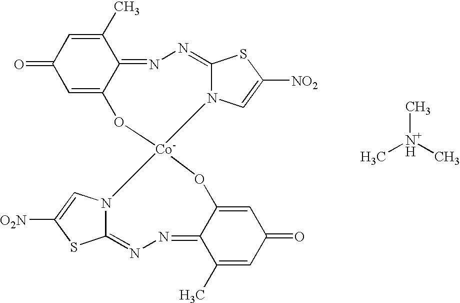 | 543 | 2.36 | 0.14 | 17 |
| 82 | 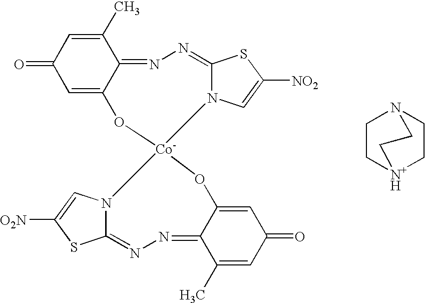 | 543 | 2.29 | 0.066 | 21 |
| 83 | 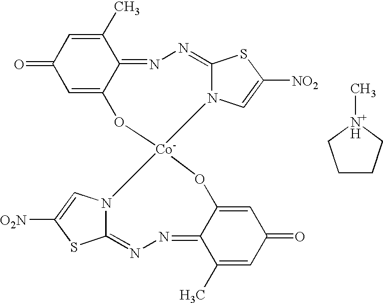 | 545 | 2.33 | 0.083 | 22 |
| 84 | 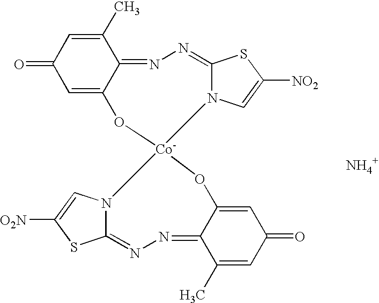 | 556 | 2.25 | 0.27 | 24 |
| 85 | 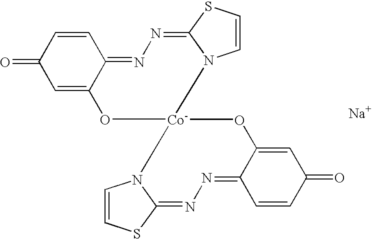 | 511 | 2.32 | 0.121 | 3 |
| 86 | 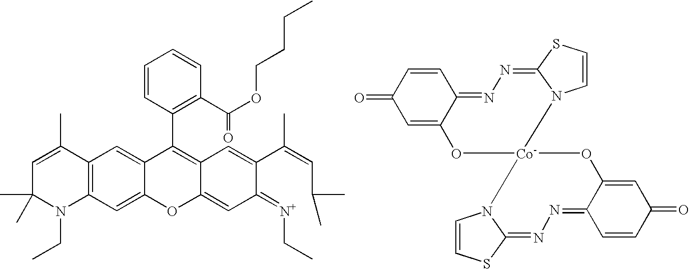 | 615 | 2.42 | 0.065 | 16 |
| 87 | 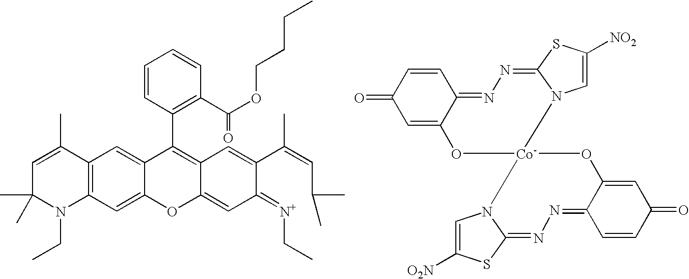 | 613 | 2.44 | 0.044 | 7 |
| 88 | 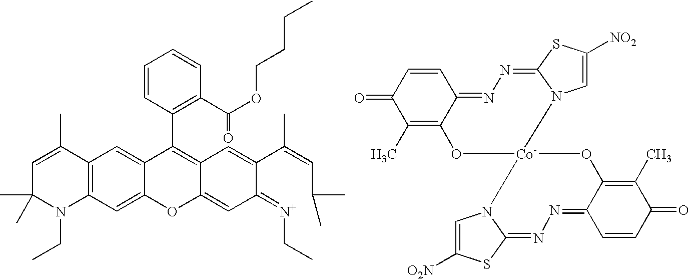 | 613 | 2.43 | 0.087 | 14 |
| 89 | 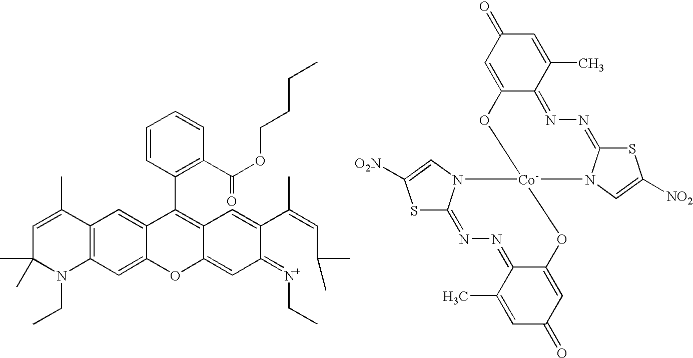 | 613 | 2.36 | 0.066 | 14 |
| 90 | 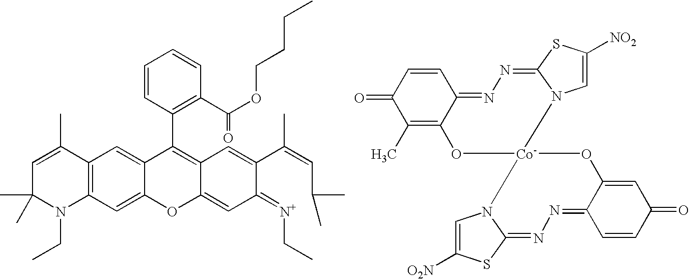 | 613 | 2.42 | 0.081 | 12 |
| 91 | 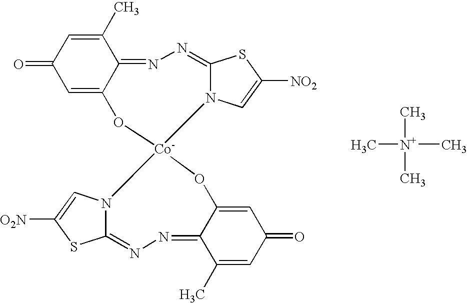 | 536 | 2.3 | 0.038 | 13 |

### EXAMPLES 92-95

The procedure is analogous to Example 75, but instead of the sodium cation there are used the following cations: K⁺, Li⁺, Cs⁺ and

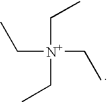

### EXAMPLE 96

The procedure is analogous to Example 18, but the compound of formula

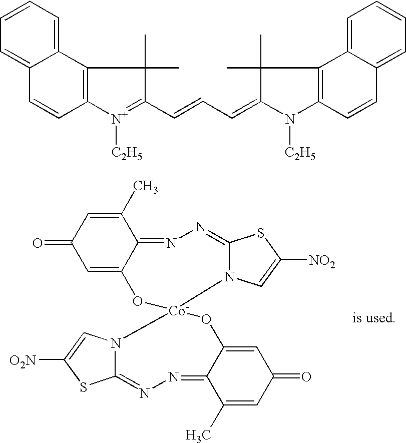

### EXAMPLE 97

The procedures is analogous to Example 96, but a 50:50 mixture of

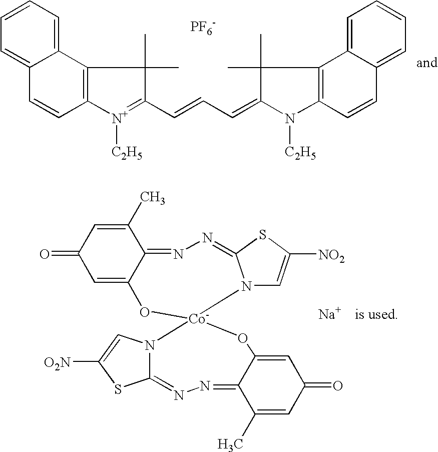

### EXAMPLE 98

The procedure is analogous to Example 97, but the components are used in a ratio of 30:70.

### EXAMPLE 99

The procedure is analogous to Example 97, but the components are used in a ratio of 70:30.

### EXAMPLE 100

The procedure is analogous to Example 96, but a mixture comprising additionally 30% 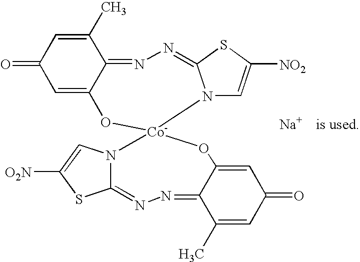
contain a further n or O atom and which can be mono- or poly-substituted by C₁-C₈alkyl;
R₁₆ and R₁₇ are each independently of the other mono- or poly-substituted C₁-C₁₂alkyl, C₂-C₁₂alkenyl, C₂-C₁₂alkynyl, C₃-C₁₂cycloalkyl, C₃-C₁₂cycloalkenyl, C₃-C₁₂heterocycloalkyl, C₇-C₁₂aralkyl, C₆-C₁₀aryl or C₅-C₉heteroaryl;
M^{r} is a transition metal cation having r positive charges;
A^{m-} is an inorganic, organic or organometallic anion, or a mixture thereof;
Zⁿ⁺ is a proton, a metal, ammonium or phosphonium cation, a positively charged organic or organometallic chromophore, or a mixture thereof;
it being possible once or more times radicals of the same or different ligands L₁, L₂, L₃ and/or L₄, each selected from the group consisting of R₁, R₂, R₃, R₄, R₅, R₆, R₇, R₈, R₉, R₁₀, R₁₁, R₁₂, R₁₄, R₁₅ and R₁₆, to be bonded to one another in pairs by way of a direct bond or an —O—, —S— or —N(R₁₇)— bridge, and/or for from 0 to p anions A^{m-} and/or from 0 to q cations Zⁿ⁺ each to be bonded to any radical R₁, R₂, R₃, R₄, R₅, R₆, R₇, R₈, R₉, R₁₀, R₁₁, R₁₂, R₁₃, R₁₄, R₁₅, R₁₆ or R₁₇ of the same or different ligands L₁, L₂, L₃ and/or L₄ or to M^{r} by way of a direct bond or an —O—, —S— or —N(R₁₇)— bridge;
k is an integer from 1 to 6;
m, n and r are each independently of the others an integer from 1 to 4; preferably m and n are 1 or 2 and r is 2 or 3; o is a number from 1 to 4; and
p and q are each a number from 0 to 4, the ratio of o, p and q to one another, according to the charge of the associated sub-structures, being such that in formula (I), (II) or (III) there is no resulting excess positive or negative charge;
and with the further proviso that when R₁, R₃, R₄, R₅, R₇ and R₈ are all H, R₂ is OH, R₆ is NO₂, M is Co and r is 3, [Zⁿ⁺]_{q} does not have the formula

1. An optical recording medium comprising a substrate, a reflecting layer and a recording layer, wherein the recording layer comprises a compound of formula [L₁M^{r-4}L₂]ₒ [A^{m-}]ₚ [Zⁿ⁺]_{q} (I), [L₁M^{r-3}L₃]ₒ [A^{m-}]ₚ [Zⁿ⁺]_{q} (II) or [L₃M^{r-2}L₄]ₒ [A^{m-}]ₚ [Zⁿ⁺]_{q} (III), which compound of formula (I), (II) or (III) may also be in a mesomeric or tautomeric form, wherein
L₁ and L₂ are each independently of the other 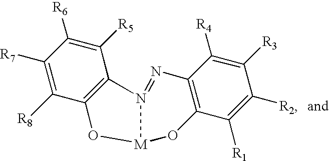
L₃ and L₄ are each independently of the other 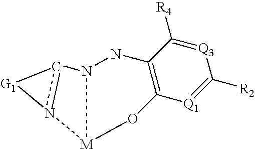
M indicating the position of M^{r-4}, M^{r-3} or M^{r-2} in (I), (II) or (III), respectively; 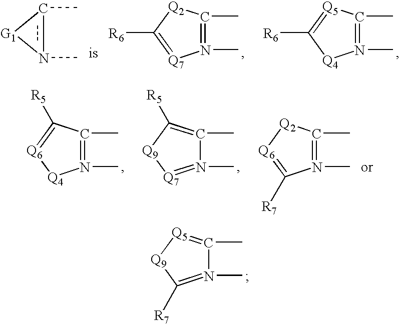
Q₁ is CR₁ or N, Q₂ is O, S, NR₁₀ or Q₅═Q₈, Q₃ is CR₃ or N, Q₄ is O, S, NR₁₀ or Q₇═Q₈, Q₅ is CR₅ or N, Q₆ is CR₆ or N, Q₇ is CR₇ or N, Q₈ is CR₈ or N, and Q₉ is O, S, NR₁₀ or Q₆═Q₈,
and in the case of tautomers Q₁ may also be NR₁ and/or Q₃ may also be NR₃;
R₁, R₃, R₄, R₅, R₆, R₇ and R₈ are each independently of the others H, halogen, OR₉, SR₉, NR₁₀R₁₅, NR₁₀COR₁₁, NR₁₀COOR₉, NR₁₀CONR₁₂R₁₃, NR₁₀CN, OSiR₁₀R₁₁R₁₄, COR₁₀, CR₁₀OR₁₁OR₁₄, NR₉R₁₂R₁₃⁺, NO₂, CN, CO₂⁻, COOR₉, SO₃⁻, CONR₁₂R₁₃, SO₂R₁₀, SO₂NR₁₂R₁₃, SO₃R₉, PO₃⁻, PO(OR₁₀)(OR₁₁); C₁-C₁₂alkyl, C₂-C₁₂alkenyl, C₂-C₁₂alkynyl, C₃-C₁₂cycloalkyl, C₃-C₁₂cycloalkenyl or C₃-C₁₂heterocycloalkyl each unsubstituted or mono- or poly-substituted by halogen, OR₉, SR₉, NR₁₀R₁₅, NR₁₀COR₁₁, NR₁₀COOR₉, NR₁₀CONR₁₂R₁₃, NR₁₀CN, OSiR₁₀R₁₁R₁₄, COR₁₀, CR₁₀OR₁₁OR₁₄, NR₉R₁₂R₁₃⁺, NO₂, CN, CO₂⁻, COOR₉, SO₃⁻, CONR₁₂R₁₃, SO₂R₁₀, SO₂NR₁₂R₁₃ and/or SO₃R₉; or C₇-C₁₂aralkyl, C₆-C₁₀aryl or C₅-C₉heteroaryl each unsubstituted or mono- or poly-substituted by R₁₀, halogen, OR₉, SR₉, NR₁₀ R₁₅, NR₁₀COR₁₁, NR₁₀COOR₉, NR₁₀CONR₁₂R₁₃, NR₁₀CN, OSiR₁₀R₁₁R₁₄, COR₁₀, CR₁₀OR₁₁OR₁₄, NR₉R₁₂R₁₃⁺, NO₂, CN, CO₂⁻, COOR₉, SO₃⁻, CONR₁₂R₁₃, SO₂R₁₀, SO₂NR₁₂R₁₃, SO₃R₉, PO₃⁻, PO(OR₁₀)(OR₁₁), SiR₁₀R₁₁R₁₄ and/or SiOR₁₀OR₁₁OR₁₄;
R₂ is OR₉, SR₉, NR₁₀R₁₅, NR₁₀COR₁₁, NR₁₀COOR₉, NR₁₀CONR₁₂R₁₃ or NR₁₀CN;
each R₉, independently of any other R₉, is R₁₅, COR₁₅, COOR₁₅, CONR₁₂R₁₃, CN or a negative charge, preferably H or a negative charge;
R₁₀, R₁₁ and R₁₄ are each independently of the others hydrogen, C₁-C₁₂alkyl, C₂-C₁₂alkenyl, C₂-C₁₂alkynyl, [C₂-C₈alkylene-O—]ₖ—R₁₆, [C₂-C₈alkylene-NR₁₇—]ₖ—R₁₆ or C₇-C₁₂aralkyl, it being possible for R₁₀ in NR₁₀R₁₅, NR₁₀COR₁₁, NR₁₀COOR₉, NR₁₀CONR₁₂R₁₃ or NR₁₀CN additionally to be a delocalisable negative charge;
R₁₂, R₁₃ and R₁₅ are each independently of the others H; C₁-C₁₂alkyl, C₂-C₁₂alkenyl, C₂-C₁₂alkynyl, C₃-C₁₂cycloalkyl, C₃-C₁₂cycloalkenyl or C₃-C₁₂heterocycloalkyl each unsubstituted or mono- or poly-substituted by halogen, OR₁₀, SR₁₀, NR₁₀COR₁₁, NR₁₀COOR₁₁, NR₁₀CONR₁₁R₁₄, OSiR₁₀R₁₁R₁₄, COR₁₀, CR₁₀OR₁₁OR₁₄, NR₁₀R₁₁R₁₄⁺, NO₂, CN, CO₂⁻, COOR₁₀, SO₃⁻, CONR₁₁R₁₄, SO₂NR₁₁R₁₄, SO₂R₁₀, NR₁₁R₁₄ and/or SO₃R₁₀; or C₇-C₁₂aralkyl, C₆-C₁₂aryl or C₅-C₉heteroaryl each unsubstituted or mono- or poly-substituted by R₁₀, halogen, OR₁₀, SR₁₀, NR₁₀COR₁₁, NR₁₀COOR₁₁, NR₁₀CONR₁₁R₁₄, OSiR₁₀R₁₁R₁₄, COR₁₀, CR₁₀OR₁₁OR₁₄, NR₁₀R₁₁R₁₄⁺, NO₂, CN, CO₂⁻, COOR₁₄, SO₃⁻, CONR₁₁R₁₄₁, SO₂R₁₀, SO₂NR₁₁R₁₄, SO₃R₁₀, PO₃⁻, PO(OR₁₀)(OR₁₁), NR₁₁R₁₄, SiR₁₀R₁₁R₁₄ and/or SiOR₁₀OR₁₁OR₁₄; or NR₁₂R₁₃, NR₁₁R₁₄ or NR₁₀R₁₅ is a five- or six-membered heterocycle which may contain a further N or O atom and which can be mono- or poly-substituted by C₁-C₈alkyl;
R₁₆ and R₁₇ are each independently of the other mono- or poly-substituted C₁-C₁₂alkyl, C₂-C₁₂alkenyl, C₂-C₁₂alkynyl, C₃-C₁₂cycloalkyl, C₃-C₁₂cycloalkenyl, C₃-C₁₂heterocycloalkyl, C₇-C₁₂aralkyl, C₆-C₁₀aryl or C₅-C₉heteroaryl;
M^{r} is a transition metal cation having r positive charges;
A^{m-} is an inorganic, organic or organometallic anion, or a mixture thereof;
Zⁿ⁺ is a proton, a metal, ammonium or phosphonium cation, a positively charged organic or organometallic chromophore, or a mixture thereof;
it being possible once or more times radicals of the same or different ligands L₁, L₂, L₃ and/or L₄, each selected from the group consisting of R₁, R₂, R₃, R₄, R₅, R₆, R₇, R₈, R₉, R₁₀, R₁₁, R₁₂, R₁₄, R₁₅ and R₁₆, to be bonded to one another in pairs by way of a direct bond or an —O—, —S— or —N(R₁₇)— bridge, and/or for from 0 to p anions A^{m-} and/or from 0 to q cations Zⁿ⁺ each to be bonded to any radical R₁, R₂, R₃, R₄, R₅, R₆, R₇, R₈, R₉, R₁₀, R₁₁, R₁₂, R₁₃, R₁₄, R₁₅, R₁₆ or R₁₇ of the same or different ligands L₁, L₂, L₃ and/or L₄ or to M^{r} by way of a direct bond or an —O—, —S— or —N(R₁₇)— bridge;
k is an integer from 1 to 6;
m, n and r are each independently of the others an integer from 1 to 4; and r is 2 or 3; o is a number from 1 to 4; and
p and q are each a number from 0 to 4, the ratio of o, p and q to one another, according to the charge of the associated sub-structures, being such that in formula (I), (II) or (III) there is no resulting excess positive or negative charge;
and with the further proviso that when R₁, R₃, R₄, R₅, R₇ and R₈ are all H, R₂ is OH, R₆ is NO₂, M is Co and r is 3, [Zⁿ⁺]_{q} does not have the formula 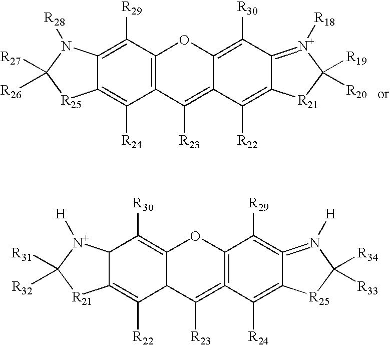
wherein R₁₈ and R₂₈ are each independently of the other hydrogen; C₁-C₂₄alkyl, C₂-C₂₄alkenyl, C₂-C₂₄alkynyl, C₃-C₂₄cycloalkyl, C₃-C₂₄cycloalkenyl or C₃-C₁₂heterocycloalkyl each unsubstituted or mono- or polysubstituted by halogen, NO₂, CN, NR₃₅R₃₆, NR₃₅R₃₆R₃₇⁺, NR₃₅COR₃₆, NR₃₅CONR₃₅R₃₆, OR₃₅, SR₃₅, COO⁻, COOH, COOR₃₅, CHO, CR₃₇OR₃₅OR₃₆, COR₃₅, SO₂R₃₅, SO₃⁻, SO₃H, SO₃R₃₅ or OSiR₃₇R₃₈R₃₉; or C₇-C₁₈aralkyl, C₆-C₁₄aryl or C₄-C₁₂heteroaryl each unsubstituted or mono- or poly-substituted by halogen, NO₂, CN, NR₃₅R₃₆, NR₃₅R₃₆R₃₇⁺, NR₃₅COR₃₆, NR₃₇CONR₃₅R₃₆, R₃₅, OR₃₅, SR₃₅, CHO, CR₃₇OR₃₅OR₃₆, COR₃₅, SO₂R₃₅, SO₃⁻, SO₃R₃₅, SO₂NR₃₅R₃₆, COO⁻, COOR₃₅, CONR₃₅R₃₆, PO₃⁻, PO(OR₃₅)(OR₃₆), SiR₃₇R₃₈R₃₉, OSiR₃₇R₃₈R₃₉ or SiOR₃₇OR₃₈OR₃₉; but R₁₈ and R₂₈ are not simultaneously hydrogen;
R₁₉, R₂₀, R₂₆ and R₂₇ are each independently of the others C₁-C₁₂alkyl unsubstituted or mono- or poly-substituted by halogen, OR₃₇, SR₃₇, NO₂, CN, NR₄₀R₄₁, COO⁻, COOH, COOR₃₇, SO₃⁻, SO₃H or SO₃R₃₇,
it being possible for R₁₉ and R₂₀ and/or R₂₆ and R₂₇ and/or R₃₁ and R₃₂ and/or R₃₃ and R₃₄ to be so bonded to one another in pairs by way of a direct bond or an —O—, —S— or —NR₄₂— bridge that together they form a 5- to 12-membered ring;
R₂₁ and R₂₅ are each independently of the other C₁-C₃alkylene or C₁-C₃alkenylene each unsubstituted or mono- or poly-substituted by halogen, R₄₂, OR₄₂, SR₄₂, NO₂, CN, NR₄₃R₄₄, COO⁻, COOH, COOR₄₂, SO₃⁻, SO₃H or SO₃R₄₂;
R₂₂, R₂₄, R₂₉ and R₃₀ are each independently of the others hydrogen, halogen, OR₄₅, SR₄₅, NO₂, NR₄₅R₄₆; or C₁-C₂₄alkyl, C₂-C₂₄alkenyl, C₂-C₂₄alkynyl, C₃-C₂₄cycloalkyl, C₃-C₂₄cycloalkenyl, C₃-C₁₂heterocycloalkyl or C₇-C₁₈aralkyl each unsubstituted or mono- or poly-substituted by halogen, OR₄₅, SR₄₅, NO₂, CN or NR₄₅R₄₆;
R₂₃ is hydrogen; (CH₂)ₖCOO⁻, (CH₂)ₖCOOR₄₇, C₁-C₂₄alkyl, C₂-C₂₄alkenyl, C₂-C₂₄alkynyl, C₃-C₂₄cycloalkyl or C₃-C₂₄cycloalkenyl each unsubstituted or mono- or poly-substituted by halogen, NR₄₇R₄₈ or OR₄₈; or C₇-C₁₈aralkyl, C₆-C₁₄aryl or C₅-C₁₃heteroaryl each unsubstituted or mono- or poly-substituted by halogen, NO₂, CN, NR₄₇R₄₈, SO₃⁻, SO₃R₄₇, SO₂NR₄₇R₄₈, COO⁻, (CH₂)ₖOR₄₇, (CH₂)ₖOCOR₄₇, COOR₄₇, CONR₄₇R₄₈, OR₄₇, SR₄₇, PO₃⁻, PO(OR₄₇)(OR₄₈) or SiR₃₇R₃₈R₃₉;
R₃₁, R₃₂, R₃₃ and R₃₄ are each independently of the others C₁-C₁₂alkyl unsubstituted or mono- or poly-substituted by halogen, OR₃₅, SR₃₅, NO₂, CN, NR₄₀R₄₁, COOR₃₇, SO₃⁻, SO₃H or SO₃R₃₅;
R₃₅, R₃₆, R₄₀, R₄₁, R₄₂, R₄₃, R₄₄, R₄₅, R₄₆, R₄₇ and R₄₈ are each independently of the others hydrogen; C₁-C₂₄alkyl, C₂-C₂₄alkenyl, C₂-C₂₄alkynyl, C₃-C₂₄cycloalkyl, C₃-C₂₄cycloalkenyl or C₃-C₁₂heterocycloalkyl each unsubstituted or mono- or poly-substituted by halogen, NO₂, CN, NR₃₇R₃₈, NR₃₇R₃₈R₃₉⁺, NR₃₇COR₃₈, NR₃₇CONR₃₈R₃₉, OR₃₇, SR₃₇, COO⁻, COOH, COOR₃₇, CHO, CR₃₇OR₃₈OR₃₉, COR₃₇, SO₂R₃₇, SO₃⁻, SO₃H, SO₃R₃₇ or OSiR₃₇R₃₈R₃₉; or C₇-C₁₈aralkyl, C₆-C₁₄aryl or C₅-C₁₃heteroaryl each unsubstituted or mono- or poly-substituted by halogen, NO₂, CN, NR₃₇R₃₈, NR₃₇R₃₈R₃₉⁺, NR₃₇COR₃₈, NR₃₇CONR₃₈R₃₉, R₃₇, OR₃₇, SR₃₇, CHO, CR₃₇OR₃₈OR₃₉, COR₃₇, SO₂R₃₇, SO₃⁻, SO₂NR₃₇R₃₈, COO⁻, COOR₃₉, CONR₃₇R₃₈, PO₃⁻, PO(OR₃₇)(OR₃₈), SiR₃₇R₃₈R₃₉, OSiR₃₇R₃₈R₃₉ or
SiOR₃₇OR₃₈OR₃₉;
or NR₃₅R₃₆, NR₄₀R₄₁, NR₄₃R₄₄, NR₄₅R₄₆ or NR₄₇R₄₈ are a five- or six-membered heterocycle which may contain a further N or O atom and which can be mono- or poly-substituted by C₁-C₈alkyl;
R₃₇, R₃₈ and R₃₉ are each independently of the others hydrogen, C₁-C₂₀alkyl, C₂-C₂₀alkenyl, C₂-C₂₀alkynyl or C₇-C₁₈aralkyl, it being possible for R₃₇ and R₃₈ to be bonded to one another by way of a direct bond or an —O—, —S— or —NC₁-C₈alkyl-bridge so that together they form a five- or six-membered ring;
it being possible for from 1 to 4 radicals selected from the group consisting of R₁₈, R₁₉, R₂₁, R₂₂, R₂₃, R₂₄, R₂₅, R₂₆, R₂₈, R₂₉, R₃₀, R₃₅, R₃₆, R₃₇, R₃₈, R₃₉, R₄₀, R₄₁, R₄₂, R₄₃, R₄₄, R₄₅, R_{46,} R₄₇ and R₄₈ to be bonded to one another in pairs by way of a direct bond or an —O—, —S— or —N(G)— bridge or bonded singly to A^{m-} and/or Zⁿ⁺, wherein G is mono- or poly-substituted C₁-C₂₄alkyl, C₂-C₂₄alkenyl, C₂-C₂₄alkynyl, C₃-C₂₄cycloalkyl, C₃-C₂₄cycloalkenyl, C₃-C₁₂heterocycloalkyl, C₇-C₁₈aralkyl, C₆-C₁₄aryl or C₅-C₁₃heteroaryl.

2. An optical recording medium according to claim 1, wherein R₂ and R₄ are hydroxy, O⁻, mercapto or S⁻ and R₆ or R₇ is nitro or cyano; Zⁿ⁺ is a xanthene; and/or R₁₀ is methyl, ethyl, n-propyl, isopropyl, n-butyl, 2-butyl, isobutyl, tert-butyl, 3-pentyl, n-amyl, tert-amyl, neopentyl, 2,2-dimethyl-but-4-yl, 2,2,4-trimethyl-pent-5-yl, cyclopropyl, cyclopropylmethyl, cyclobutyl, cyclobutylmethyl, cyclopentyl, cyclopentylmethyl, cyclohexyl, cyclohexylmethyl, cyclohex-4-enyl-methyl, 5-methyl-cyclohex-4-enyl-methyl or 2-ethyl-hexyl, each unsubstituted or mono- or poly-substituted by fluorine.

3. An optical recording medium according to claim 1, wherein M^{r+} is Co²⁺, Co³⁺, Cu⁺, Cu²⁺, Zn²⁺, Cr³⁺, Ni²⁺, Fe²⁺, Fe³⁺, Al³⁺, Ce²⁺, Ce³⁺, Mn²⁺, Mn³⁺, Si⁴⁺, Ti⁴⁺, V³⁺, V⁵⁺ or Zr⁴⁺.

4. An optical recording medium according to claim 1, additionally comprising a cyanine or xanthene cation.

5. A method for the optical recording, storage or playback of information, wherein a recording medium according to claim 1, is used.

6. A method according to claim 5, wherein the recording and/or the playback take place in a wavelength range of from 600 to 700 nm.

7. A method of producing an optical recording medium, wherein a solution of a compound of formula (I), (II) or (III) according to claim 1, in an organic solvent is applied to a substrate having depressions.

8. A method for the optical recording, storage or playback of information, wherein a recording medium according to claim 3 is used.

9. A method according to claim 8, wherein the recording and/or the playback take place in a wavelength range of from 600 to 700 nm.

10. A compound of formula (II) or (III) according to claim 1, or a tautomeric or mesomeric form thereof wherein R₂ is O⁻, S⁻, N⁻COR₁₁, N⁻COOR₉, N⁻CONR₁₂R₁₃ or N⁻CN.

11. An optical recording medium according to claim 1, wherein either Q₁ is CR₁ and Q₃ is CR₃ or Q₁ and Q₃ are both N, and/or Q₈ in Q₅═Q₈, Q₆═Q₈ or Q₇═Q₈ is in the β-position relative to the nitrogen atom of

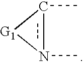

12. An optical recording medium according to claim 2, wherein M^{r+} is Co²⁺, Co³⁺, Cu⁺, Cu²⁺, Zn²⁺, Cr³⁺, Ni²⁺, Fe²⁺, Fe³⁺, Al³⁺, Ce²⁺, Ce³⁺, Mn²⁺, Mn³⁺, Si⁴⁺, Ti⁴⁺, V³⁺, V⁵⁺ or Zr⁴+.

13. An optical recording medium according to claim 4, wherein the cyanine or xanthene cation is a benzoindocarbocyanine or rhodamine cation.

14. An optical recording medium according to claim 2 additionally comprising a cyanine or xanthene cation.

15. An optical recording medium according to claim 14, wherein the cyanine or xanthene cation is a benzoindocarbocyanine or rhodamine cation.

16. A method according to claim 5, wherein the recording and/or the playback take place in a wavelength range of from 630 to 690 nm.

17. A method according to claim 5, wherein the recording and/or the playback take place in a wavelength range of from 650 to 670 nm.

18. A method for the optical recording, storage or playback of information, wherein a recording medium according to claim 2 is used.

19. A method according to claim 18, wherein the recording and/or the playback take place in a wavelength range of from 600 to 700 nm.
